(19) United States
(12) Patent Application Publication
(10) Pub. No.: US 2019/0380336 A1
(43) Pub. Date: Dec. 19, 2019

(54) NEMATODE DETERRENT COMPOSITIONS

(71) Applicants: SALK INSTITUTE FOR BIOLOGICAL STUDIES, La Jolla, CA (US); CORNELL UNIVERSITY, Ithaca, NY (US); BOYCE THOMPSON INSTITUTE, Ithaca, NY (US)

(72) Inventors: Sreekanth H. Chalasani, San Diego, CA (US); Zheng Liu, San Diego, CA (US); Frank Schroeder, Ithaca, NY (US); Maro Kariya, Brooklyn, NY (US)

(21) Appl. No.: 16/444,670

(22) Filed: Jun. 18, 2019

Related U.S. Application Data
(60) Provisional application No. 62/686,444, filed on Jun. 18, 2018.

(51) Int. Cl. A01N 37/02; A01N 31/02; A01N 37/06; A01N 25/04

(52) U.S. Cl. CPC A01N 37/02; A01N 25/04; A01N 37/06; A01N 31/02

(57) ABSTRACT

The present disclosure provides compositions comprising a nematode deterrent comprising a compound of Formula I. Also provided are related articles of manufacture, uses and methods.

### CROSS-REFERENCE TO RELATED APPLICATION

This application claims priority to U.S. Provisional Patent Application No. 62/686,444, filed on Jun. 18, 2018, which is incorporated by reference herein.

### STATEMENT OF GOVERNMENT INTEREST

This invention was made with government support under Grant Nos. AT008764, MH098001, and MH113905 awarded by the National Institutes of Health. The government has certain rights in the invention.

### BACKGROUND

Nematodes are microscopic roundworms that live in the soil and on plant roots and represent a type of plant pests in certain parts of the United States. Nematodes are particularly a problem in areas with warm temperatures and sandy soils and negatively impact lawns throughout the Southeastern United States. Nematodes cause injury to lawns by feeding on plant root cells which damages the root system preventing proper water and nutrient absorption by the plant. The lawn is then weakened and more susceptible to other stresses, such as drought.

### SUMMARY

Data presented herein demonstrate that certain sulfolipid compounds are effective at deterring nematodes. As shown herein, such compounds can prevent, reduce or delay egg laying by nematodes. Accordingly, the present disclosure provides compositions effective for deterring nematodes and related methods.

The present disclosure provides compositions comprising a nematode deterrent comprising a compound of Formula I:

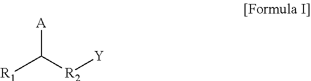

wherein:
A is OSO₃ or OSO₃H
R₁ is a C₁-C₂₄ branched or linear alkyl or alkenyl, optionally substituted with —OH or ═O at one or more carbon atoms,
R₂ is a C₁-C₁₄ branched or linear alkyl or alkenyl, optionally substituted with —OH or ═O at one or more carbon atoms, and
Y is —OH or —COOH;
or a salt thereof.

The present disclosure also provides an article of manufacture comprising the composition described herein.

The present disclosure further provides uses of the compositions and articles of manufacture described herein. In exemplary embodiments, the composition or article is used for treating or preventing a nematode infestation of a plant or a set of plants, e.g., plants of an agricultural crop. In exemplary embodiments, the composition or articles is used for a nematode infection in a subject in need thereof.

Accordingly, the present disclosure provides methods for treating or preventing a nematode infestation of a plant or a set of plants, e.g., plants of an agricultural crop. In exemplary embodiments, the method comprises applying a composition described herein, or an article of manufacture comprising the same, to the plant or soil surrounding the plant in an amount effective to treat or prevent a nematode infestation. Also, the present disclosure provides methods for treating or preventing a nematode infection in a subject in need thereof. In exemplary embodiments, the method comprises administering the composition described herein, or an article of manufacture comprising the same, to the subject in an amount effect effective to treat or prevent the nematode infection in the subject.

### BRIEF DESCRIPTION OF THE DRAWINGS

FIG. 1A-FIG. 1I demonstrate predator-released sulfolipids drive C. elegans behaviors. FIG. 1A C. elegans avoid excretions from starving P. pacificus PS (P5312, domesticated) and RS (RS5725B a wild isolate, predator cue) strains. Inset shows a schematic of the avoidance assay. FIG. 1B Top shows schematic of the modified egg-laying assay and bottom, C. elegans lay fewer eggs after a 30 min exposure to concentrated predator cue, but recovers after 2 h. FIG. 1C UHPLC-HRMS analysis re a complex mixture of >10,000 metabolites, which was subjected to multistage activity-guided fractionation using reverse-phase chromatography. After four fractionation steps, most of the activity (++) was found in fraction x. Averages and s.e.m. are shown. n>30 for each condition. FIG. 1D UHPLC-HRMS ion chromatograms (m/z value±5 ppm) of active fraction x and adjacent fractions for two sulfate-containing metabolites that were strongly enriched in the active fraction (left). MS-MS analysis (right) confirms presence of sulfate moieties in both compounds. FIG. 1E Schematic representation of 2D NMR-based comparative metabolomics (left) of consecutive fractions (x−2 to x+2) used to identify signals specific to fraction x. Cropped 2D NMR (dqfCOSY) spectrum (right) of active fraction highlighting signals that represent specific features of the identified metabolites (gray lines define edges of shown subsections). FIG. 1F Chemical structures of metabolites identified via comparative metabolomics from active fraction x, sufac#1 and sufal#2. Gray arrows indicate important correlations observed in heteronuclear 2D NMR (HMBC) spectra. FIG. 1G Synthesis of sufac#1; THF: tetrahydrofuran. FIG. 1H Homologous metabolites sufac#2 and sufal#1 were also detected by UHPLC-HRMS. FIG. 1I Chemical structure of sodium dodecyl sulfate (SUS). Averages and s.e.m. are shown and number of animals tested are indicated on each bar or condition. *p<0.05 obtained by comparison with controls using Fisher's exact t-test with Bonferroni correction

FIG. 2A-FIG. 2G demonstrate multiple sensory neurons are required for avoidance of predator cue. FIG. 2A Schematic showing amphid sensory neurons with key neurons highlighted. FIG. 2B Cell and (FIG. 2C) genetic ablations showing that ASJ, ASH, ASI, and AUL sensory neurons, but not other amphid neurons, are required for avoidance of predator cue. Averages, s.e.m. and numbers of animals tested are shown on each bar. FIG. 2D-FIG. 2G Average calcium responses of transgenic animals (n>13 for each condition) expressing the GCaMP family of indicators in FIG. 2D ADL, FIG. 2E ASH, FIG. 2F ASI, or FIG. 2G ASJ sensory neurons to predator cue (P cue) or C. elegans secretions (N2 cue). Each experiment was a 180 s recording where control (M9 buffer), C. elegans secretions (N2 cue), or predator cue (Pcue) in different dilutions was added at 10 s and removed at 130 s (stimulus is indicated by a shaded gray box). Bar graphs, average percentage change during the 10 s after stimulus addition (dashed box), or 15 s after stimulus removal (dashed box) are shown. Error bars and shaded regions around the curves represent s.e.m. *p<0.05 obtained by comparison with controls using Fisher's exact t-test with Bonferroni correction.

FIG. 3A-FIG. 3F demonstrate multiple sensory neurons are required for avoidance of predator cue. FIG. 3A Schematic showing amphid sensory neurons with key neurons highlighted. FIG. 3B Cell and (FIG. 3C) genetic ablations showing that ASJ, ASH, ASI, and ADL sensory neurons, but not other amphid neurons, are required for avoidance of predator cue. Averages, s.e.m. and numbers of animals tested are shown on each bar. FIG. 3D-FIG. 3F Average calcium responses of transgenic animals (n>13 for each condition) expressing the GCaMP family of indicators in FIG. 3D ADL, FIG. 3E ASH, FIG. 3F ASI, or FIG. 3F ASJ sensory neurons to predator cue (P cue) or C. elegans secretions (N2 cue). Each experiment was a 180 s recording where control (M9 buffer), C. elegans secretions (N2 cue), or predator cue (Pcue) in different dilutions was added at 10 s and removed at 130 s (stimulus is indicated by a shaded gray box). Bar graphs, average percentage change during the 10 s after stimulus addition (dashed box), or 15 s after stimulus removal (dashed box) are shown. Error bars and shaded regions around the curves represent s.e.m. *p<0.05 obtained by comparison with controls using Fisher's exact t-test with Bonferroni correction.

FIG. 4A-FIG. 4F demonstrate sertraline attenuates C. elegans responses to the P. pacificus predator. FIG. 4A Sertraline attenuates C. elegans responses to predator cue and fructose, whereas copper avoidance is only slightly reduced, FIG. 4B The effect of sertraline is lost in tax-4 and ocr-2 mutants, and modulation is restored when TAX-4 is restored to either ASI or ASJ, or when OCR-2 is restored to ASH or ADL. FIG. 4C Sertraline requires GABA, but not glutamate signaling. Sertraline modulates avoidance responses of eat-4 (glutamate receptor), but not unc-25 (glutamic acid decarboxylase, required for GABA synthesis) mutants. Adding GABA exogenously to plates restores sertraline modulation to unc-25 mutants. FIG. 4D Defective unc-25 response is rescued by expressing wild-type unc-25 cDNA under the unc-25 promoter or a RIS-selective promoter. Knocking down unc-25 specifically in RIS interneuron partially blocks sertraline modulation of predator avoidance. FIG. 4E Sertraline attenuates mutants in multiple GABA transporters including unc-47, snf-11, snf-10, and unc-46 (a transmembrane protein that recruits UNC-47). FIG. 4F Animals were treated with predator cue or predator cue and sertraline for 30 miii and egg-laying was monitored for 60 min after removal of these compounds. FIG. 4G C. elegans detects predator cue using sensory circuits consisting of ASI, ASJ, ASH, and ADL neurons that use CNG and TRP channels and act in a redundant manner to generate rapid avoidance. In contrast, CNG channels act in ASI and ASJ neurons to reduce egg laying over many minutes. Sertraline attenuates both predator-induced avoidance behavior and egg-laying behavior downstream of these sensory neurons. Averages of either n>30 (FIG. 4A-FIG. 4E) or n>35 (FIG. 4F) and s.e.m. are shown. *p<0.05 compared to controls obtained using Fisher's exact t-test with Bonferroni correction (FIG. 4A-FIG. 4 and *p<0.05 compared to controls obtained using a two-way ANOVA (FIG. 4F)

FIG. 5 is an overview of synthesis of sufac#1. Reagents and conditions: a PCC, DCM, 0° C.; b Mg, THE argon; c SO₃/pyridine complex, pyridine; d NaOH, H₂O

FIG. 6 is an overview of synthesis of sufal#1. Reagents and conditions: a LiAlH₄, THE; b t-butyldiphenylsilyl chloride (TBDPS-Cl), imidazole, THE; c SO₃/pyridine complex, pyridine; d acetyl chloride, MeOH

FIG. 7 is an overview of synthesis of sufal#2. Reagents and conditions: a Pyridinium chlorochromate (PCC), DCM, 0° C.; b Mg, THE, argon; c LiAlH₄, THF; d TBDPS-Cl, imidazole, THF; e SO₃/pyridine complex, pyridine.

FIG. 8A-FIG. 8D show C. elegans responds to a water soluble, but not volatile component of predator secretions. FIG. 8A, C. elegans shows strong avoidance to secretions collected from starving, but not well-fed, Pristionchus pacificus (RS5275B). FIG. 8B, Avoidance responses of multiple C. elegans isolates to Control and predator cue: CB4852, N2 (Oxford, England), AB1 (from Adelaide, Australia), QX1211 (from San Francisco, US), DL238 (from Hawaii, USA), JU775 (Paris, France) and CB4856 (from Hawaii, USA). FIG. 8C, Schematic showing the chemotaxis assay used to measure C. elegans responses to volatile components. Nematode secretions were placed in column A, with control (M9 buffer) in column F at the regions marked by ‘x’. Animals were placed in column C and D allowed to chemotax for 60 min and were scored as indicated. FIG. 8D, C. elegans was not attracted to or repelled by secretions collected from starving nematodes for different durations. In contrast, they showed strong responses to a known attractant, Benzaldehyde (1:200), and the repellent, 2-nonanone (undiluted). n=12, averages and s.e.m. are shown and * indicates p<0.05 fisher's exact t-test with Bonferroni correction.

FIG. 9A-FIG. 9B show properties of P. pacificus sulfates. a, HPLC-MS analysis of exometabolome extracts from P. pacificus under fed (green) and axenic (red) conditions and an extract from OP50 E. coli (black). Traces for sufac#1 and sufal#2 are shown in the upper panels and the total ion chromatogram (TIC) in the lower panel (all intensities are normalized to pasc#9 intensity). Both fed and axenic cultures produced sufac#1 and sufal#2. b, UHPLC-HRMS analysis of natural (green), synthetic (red), and natural/synthetic-coinjected sufac#1 and sufal#2 (black-dotted).

FIG. 10A-FIG. 10G show C. elegans responses to sulfates. a, EC50 concentrations for C. elegans avoidance responses to synthetic sulfates and sulfate mixtures, compared to avoidance responses to a mixture of sulfates isolated from P. pacificus exo-metabolome (for data used to calculate EC50, see FIG. 18C). FIG. 10B, Sulfolipid pre-exposure transiently attenuates egg laying behavior. Animals were pre-exposed to predator cue or DMSO for 30 minutes and the number of eggs laid in the subsequent 60 minutes are shown. FIG. 10C, C. elegans shows a dosedependent avoidance of the active sulfate-containing compounds. See FIG. 18C for responses to control stimuli Animals lacking ASJ, ASH, ASI, ADL, and ASE neurons are defective in their responses to active sulfates, as shown using d, cell and e, genetic ablations. In contrast, animals lacking ASI, ASH, and ASJ neurons are defective in their avoidance responses to SDS again shown using f, cell and g, genetic ablations Averages and s.e.m. are shown. Number of animals tested is 30 (a, c), >38 (b) and indicated in (d-g). * indicates p<0.05 comparing that strain or condition with corresponding controls obtained using Fisher's exact test with Bonferroni correction.

FIG. 11A-FIG. 11D show sensory neuron responses to nematode secretions. Heat maps showing FIG. 11A, ADL, FIG. 11B, ASH, FIG. 11C, ASI and FIG. 11D, ASJ responses to buffer, C. elegans secretions (N2 cue) and Predator cue (P cue) diluted 1:10 and 1:50. Each row represents responses from a single neuron in an animal, which was only stimulated once. Scale bars are shown on the right with warmer colors (larger ΔF/F) representing larger increases in neuronal activity. n=13-15 for each condition.

FIG. 12A-FIG. 12C show dose-dependent effects of tax-4 and ocr-2 transgenes. FIG. 12a, Mutants in tax-4, but not tax-2 channel are defective in their response to predator cue. Restoring TAX-4 function to ASI or ASJ restores normal behavior to the tax-4 null mutants in a dose-dependent manner FIG. 12B, ocr-2, but not osm-9 mutants are defective in their avoidance response to predator cue. Normal behavior is restored when ocr-2 cDNA is expressed in either ASH or ADL in a dose dependent manner FIG. 12C, Avoidance index of various mutant strains exposed to sulfolipids. * indicates p<0.05 to wildtype, while # indicates p<0.05 compared to mutants obtained using Fisher's exact t-test with Bonferroni correction.

FIG. 13A-FIG. 13D show sertraline pre-treatment attenuates C. elegans avoidance responses to predator cue and sulfolipids. FIG. 13A, Sertraline attenuates avoidance behavior upon exposure to sulfolipids. FIG. 13B, Dose dependence of sertraline attenuation of predator avoidance. FIG. 13C, Time course of the decay of the sertraline effect. The drug effects last about 30 minutes. FIG. 13D, Sertraline does not require biogenic amine signaling to exert its effects on C. elegans avoidance behavior. Sertraline modulates avoidance responses of mutants in dopamine (cat-2, (catecholamine synthase required for dopamine synthesis and dat-1, dopamine transporter), serotonin (tph-1, tryptophan hydroxylase the rate limiting step in serotonin synthesis and mod-5, serotonin re-uptake transporter), octopamine t dc-1 tyrosine decarboxylase required for synthesis of tyramine and octopamine), or tyramine signaling tbh-1 (tyramine beta-hydroxylase required for tyramine synthesis). Data in b, c, and d show C. elegans responses to predator cue. Averages and s.e.m. are shown. n>30 animals tested on at least 3 different days. * indicates p<0.05 comparing that condition with the corresponding controls obtained using Fisher's exact t-test with Bonferroni correction.

FIG. 14A-FIG. 14F are graphs of the avoidance index for different ratios of sulfolipids exhibited by Caenorhabditis. elegans (FIG. 14a); Caenorhabditis remanei (FIG. 14b); Oscheius tipulae (FIG. 14c); Oscheius carolinenesis (FIG. 14d) Steinernema carpocapsae (FIG. 14e) and Heterorhabditis bacteriophora (FIG. 14f).

FIG. 15A shows the structure of sufal#2. FIG. 15B ¹H and ¹³C NMR spectroscopic data for sufal#2 in methanol-d4. Chemical shifts were referenced to δ(CD2HOD)=3.31 and δ(13CD3OD)=49.0. 13C chemical shifts were determined via HMBC and HSQC spectra. Spectra were acquired using the Bruker Avance 800 spectrometer. 1H, 1H-J-coupling constants were determined from the acquired 1H or dqfCOSY spectra. HMBC correlations are from the proton(s) stated to the indicated 13C atom.

FIG. 16A-FIG. 16B 1H and 13C NMR spectroscopic data for sufac#1 in methanol-d4. Chemical shifts were referenced to δ(CD2HOD)=3.31 and δ(13CD3OD)=49.0. 13C chemical shifts were determined via HMBC and HSQC spectra. Spectra were acquired using the Bruker Avance 800 spectrometer. 1H, 1H-J-coupling constants were determined from the acquired 1H or dqfCOSY spectra. HMBC correlations are from the proton(s) stated to the indicated 13C atom.

FIG. 17A-FIG. 17D Comparison of 13C NMR spectroscopic data for sufac#1 and sufal#2 in methanol-d4. Chemical shifts were referenced δ(13CD3OD)=49.0. 13C chemical shifts were determined via HMBC and HSQC spectra for natural and 1D carbon for synthetic. Spectra were acquired using the Bruker Avance 800 spectrometer for natural and Varian INOVA-600 for synthetic samples.

FIG. 18A is a listing of nematode species analyzed by HPLC-MS for the presence of sulfated lipids. FIG. 18B is a table showing drugs tested for their ability to attenuate C. elegans responses to Predator cue. FIG. 18C is a table showing the independence of avoidance assay.

FIG. 19A shows the putative structure of cysul#1 and FIG. 19C shows the putative structure of cysul#2 derived from 2D NMR spectroscopy and HPLC-HRMS. FIG. 19B shows NMR spectroscopy data for cysul#1 and FIG. 19D shows NMR spectroscopy data for cysul#2. FIG. 19E (bottom) is a graph of the relative abundance plotted as a function of mass-to-charge ratio (m/z) and an enlargement of two peaks (top).

FIG. 20A shows the putative structure of osul#1 compound derived from 2D NMR spectroscopy and HPLC-HRMS. FIG. 20B shows NMR spectroscopy data for osul#1.

FIG. 21 is a listing of putative structures based on the formula and the structural pattern of previously characterized sulfates.

FIG. 22 is an illustration of an agar plate used in an experiment.

### DETAILED DESCRIPTION

The present disclosure provides compositions comprising a nematode deterrent comprising a compound of Formula I:

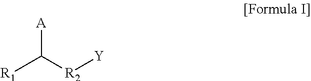

wherein:
A is —OSO₃ or —OSO₃H
R₁ is a C₁-C₂₄ branched or linear alkyl or alkenyl, optionally substituted with —OH or ═O at one or more carbon atoms,
R₂ is a C₁-C₁₄ branched or linear alkyl or alkenyl, optionally substituted with —OH or ═O at one or more carbon atoms, and
Y is —OH or —COOH;
or a salt thereof.

In exemplary embodiments, the composition comprises a nematode deterrent comprising a compound of Formula I, wherein R₂ is a C₁, C₂, C₃, C₄, C₅, C₆, C₇, C₈, C₉, C₁₀, C₁₁, C₁₂ alkyl or alkenyl, which may be branched or linear and which may be substituted at one or more carbon atoms with —OH or ═O. In exemplary embodiments, the composition comprises a nematode deterrent comprising a compound of Formula I, wherein R₂ is a C₃-C₁₂ alkyl or alkenyl, which may be branched or linear and may be substituted with —OH or ═O at one or more carbon atoms. In exemplary embodiments, the composition comprises a nematode deterrent comprising a compound of Formula I, wherein R₂ is a C₄-C₁₀ alkyl or alkenyl which may be branched or linear and may be substituted with —OH or ═O at one or more carbon atoms. In exemplary aspects, the R₂ is substituted with —OH or ═O at one, two, or three carbon atoms of the alkyl or alkenyl. In exemplary aspects, R₂ comprises one, two, or three double bonds.

In exemplary embodiments, the composition comprises a nematode deterrent comprising a compound of Formula I, wherein R₁ is a C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃ or C₂₄ alkyl or alkenyl, which may be branched or linear and which may be substituted at one or more carbon atoms with —OH or ═O. In exemplary aspects, R₁ is a C₁-C₁₂ alkyl or alkenyl. In exemplary aspects, R₁ is a C₄-C₁₂ alkyl or alkenyl. In exemplary aspects, R₁ is substituted with —OH or ═O at one, two, or three carbon atoms of the alkyl or alkenyl. In exemplary aspects, R₁ comprises one, two, or three double bonds.

In exemplary embodiments, the composition comprises a nematode deterrent comprising a structure of Formula II:

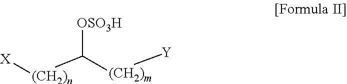

wherein:
X is —CH₃, —CH₂CH₃, —CH(CH₃)₂;
Y is —OH or —COOH;
n is an integer within 1 to 21; and
m is an integer within 1 to 13.

In exemplary embodiments, the composition comprises a nematode deterrent comprising a structure of Formula II and X is —CH(CH₃)₃. In exemplary aspects, the Y is —OH. In alternative aspects, Y is —COOH. In exemplary embodiments, the composition comprises a nematode deterrent comprising a structure of Formula II and m is 2 or 3. In exemplary aspects, the composition comprises a nematode deterrent comprising a structure of Formula II and n is 7 or 8 or 9. In exemplary aspects, the composition comprises a nematode deterrent comprising a structure of Formula II and X is —CH(CH₃)₂, Y is —OH, n is 3, and m is 8. In exemplary aspects, the composition comprises a nematode deterrent comprising a structure of Formula II and X is —CH(CH₃)₂, Y is —COOH, n is 2, and m is 8. In exemplary aspects, the composition comprises a nematode deterrent comprising a structure of Formula II and X is —CH(CH₃)₂, Y is —OH, n is 2, and m is 9. In exemplary aspects, the composition comprises a nematode deterrent comprising a structure of Formula II and X is —CH(CH₃)₂, Y is —COOH, n is 3, and m is 7.

In exemplary aspects, the composition comprises a nematode deterrent compound comprising a structure selected from the group consisting of:

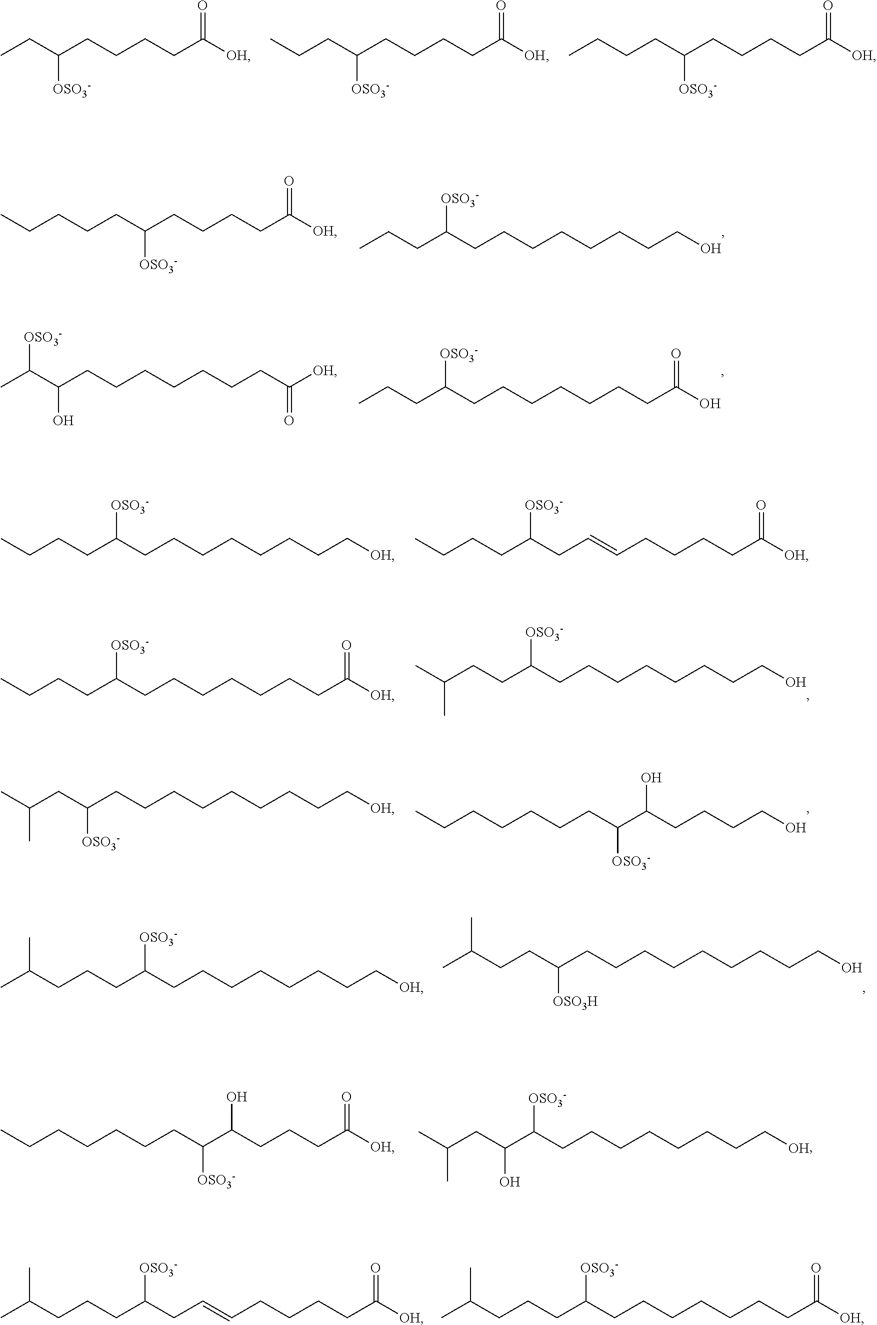

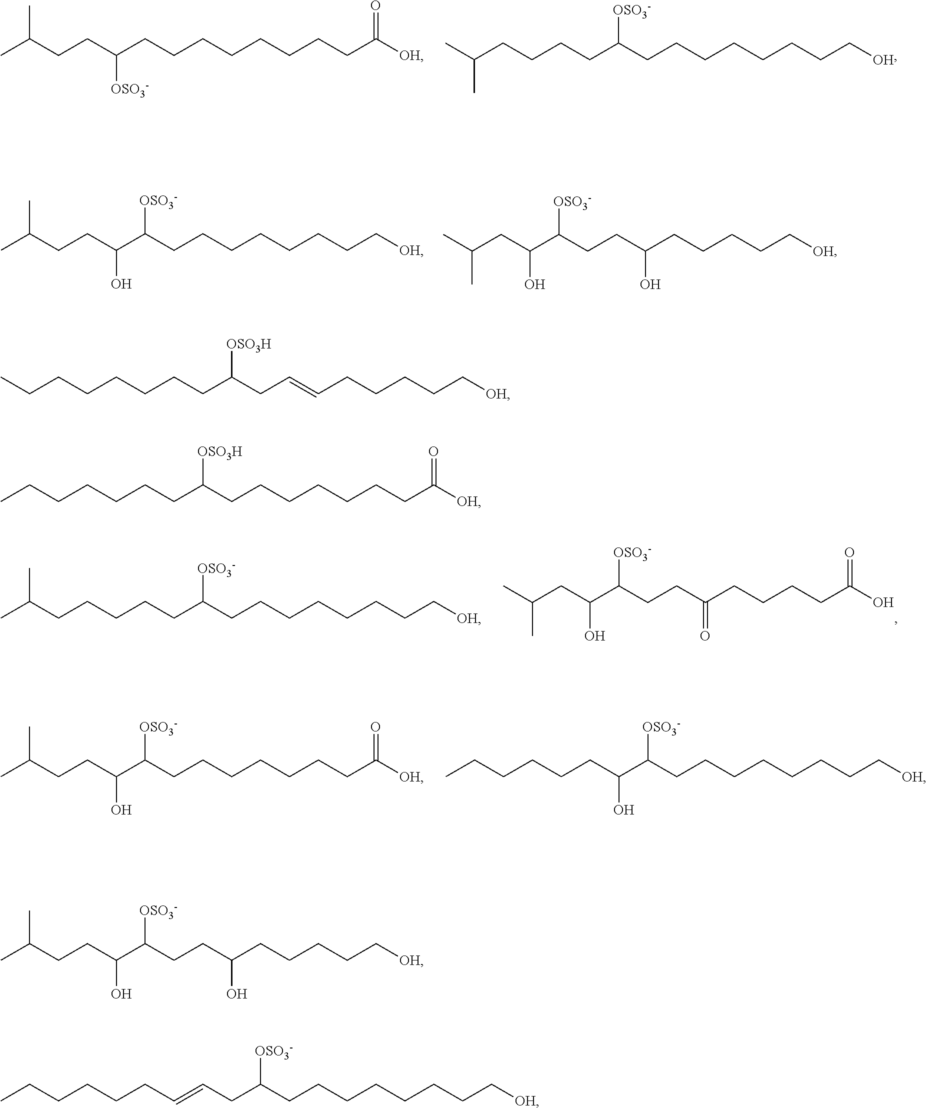

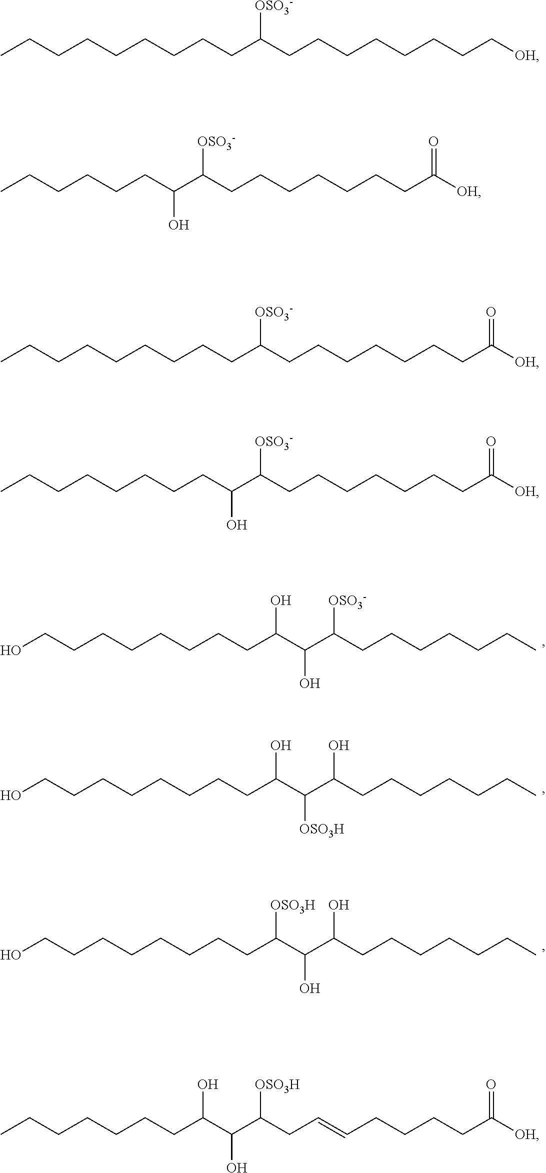

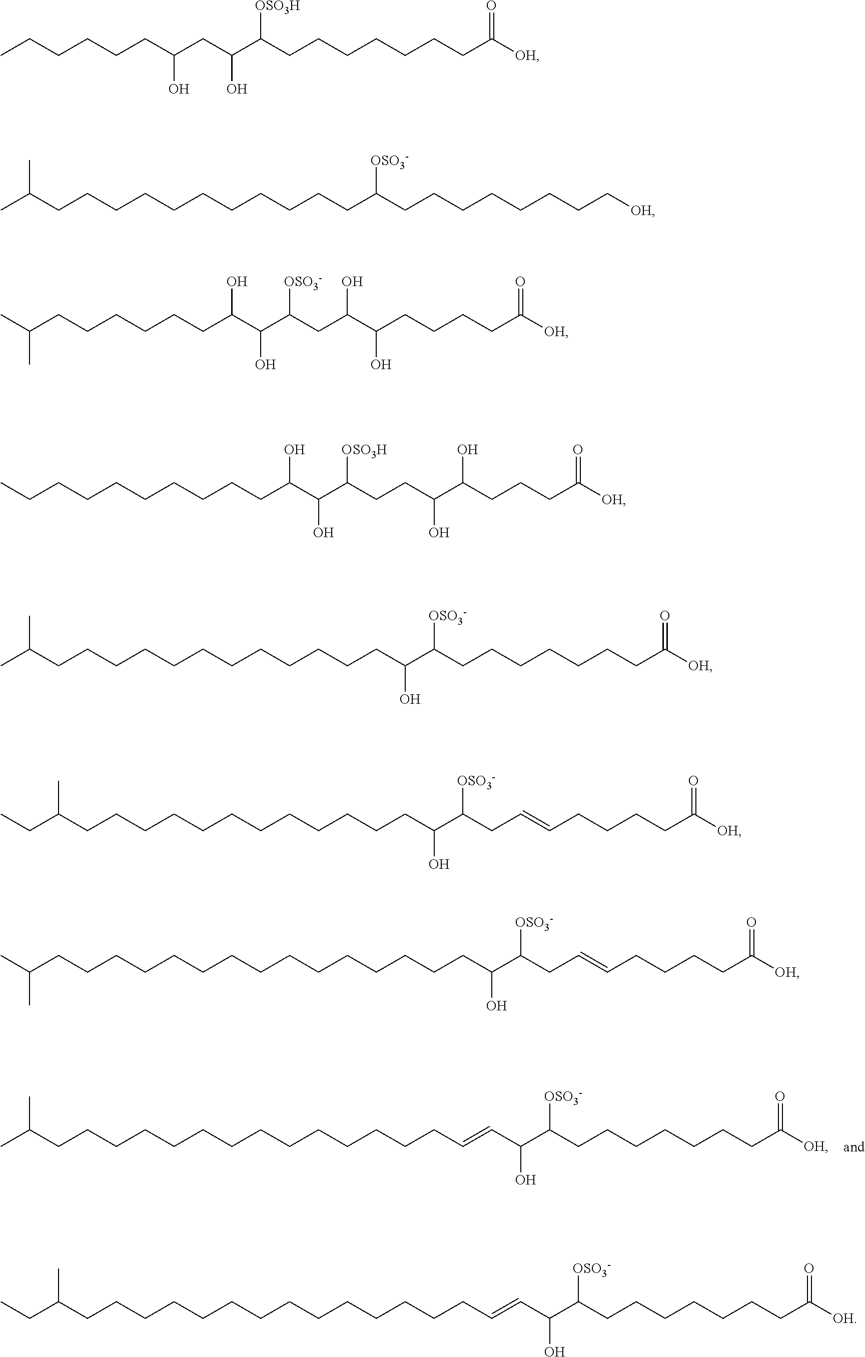

The composition of the present disclosures in exemplary embodiments comprises a single nematode deterrent compound described herein. In exemplary aspects, the composition comprises a mixture of different nematode deterrent compounds described herein. In exemplary aspects, the composition comprises at least one compound of Formula II. In exemplary aspects, the composition comprises at least one of: (a) a nematode deterrent compound comprising a structure of Formula II and X is —CH(CH₃)₂, Y is —OH, n is 3, and m is 8; (b) a nematode deterrent compound comprising a structure of Formula II and X is —CH(CH₃)₂, Y is —COOH, n is 2, and m is 8; (c) a nematode deterrent compound comprising a structure of Formula II and X is —CH(CH₃)₂, Y is —OH, n is 2, and m is 9; and (d) a nematode deterrent compound comprising a structure of Formula II and X is —CH(CH₃)₂, Y is —COOH, n is 3, and m is 7. In exemplary aspects, the composition comprises a combination of the above nematode deterrent compounds (a)-(d).

In exemplary aspects, the composition of the present disclosure comprises an aqueous solution or a liquid suspension or an emulsion comprising the nematode deterrent compound(s).

In exemplary aspects, the composition of the present disclosure comprises a solid particle comprising the compound(s). In exemplary aspects, the composition comprises a plurality of such solid particles. In exemplary aspects, the solid particles are compressed into a solid form.

In exemplary aspects, the composition of the present disclosure is a powder.

The present disclosure also provides an article of manufacture comprising the composition described herein and a pharmaceutically acceptable carrier, excipient, or diluent. In exemplary aspects, the article comprises the composition in the form of a solution of a suspension of one or more nematode deterrent compound(s) in a solvent. In exemplary aspects, the solvent is selected from the group consisting of methanol, ethanol, isopropanol, or other aliphatic alcohols, as well as mixtures of water and methanol, ethanol, isopropanol or other aliphatic alcohols. In exemplary aspects, the solvent is a dipolar-aprotic solvent, such as, for example, N-methylpyrrolidinone (NMP) or mixtures of NMP and water. In exemplary aspects, the article of manufacture comprises one or more nematode deterrent compound(s) and a surfactant.

In exemplary aspects, the article of manufacture comprises a plurality of solid particles mixed with a soil. In exemplary aspects, the plurality of solid particles is compressed into a solid form.

The present disclosure further provides uses of the compositions and articles of manufacture described herein. In exemplary embodiments, the composition or articles is used for treating or preventing a nematode infestation of a plant or a set of plants, e.g., plants of an agricultural crop. In exemplary embodiments, the composition or articles is used for a nematode infection in a subject in need thereof.

Accordingly, the present disclosure provides methods for treating or preventing a nematode infestation of a plant or a set of plants, e.g., plants of an agricultural crop. In exemplary embodiments, the method comprises applying a composition described herein, or an article of manufacture comprising the same, to the plant or soil surrounding the plant in an amount effective to treat or prevent a nematode infestation. Also, the present disclosure provides methods for treating or preventing a nematode infection in a subject in need thereof. In exemplary embodiments, the method comprises administering the composition described herein, or an article of manufacture comprising the same, to the subject in an amount effect effective to treat or prevent the nematode infection in the subject.

In exemplary aspects, the composition of the present disclosure comprises an aqueous solution or a liquid suspension or an emulsion comprising the nematode deterrent compound(s). In exemplary embodiments, the method comprises spraying the aqueous solution or a liquid suspension or an emulsion on or near the plant.

In exemplary aspects, the composition of the present disclosure comprises a solid particle comprising the compound(s). In exemplary aspects, the composition comprises a plurality of such solid particles. In exemplary aspects, the composition of the present disclosure is a powder. In exemplary embodiments, the method comprises applying the solid particles or powder on or near the plant. In exemplary aspects, the method comprises applying the solid particles or powder to the soil containing the plant.

In exemplary aspects, the solid particles are compressed into a solid form and the solid form is dissolved into a liquid, e.g., an aqueous solution, and the method comprises spraying the liquid on or near the plant. In exemplary aspects, the composition of the present disclosure is a powder and the powder is dissolved into a liquid, e.g., an aqueous solution, and the method comprises spraying the liquid on or near the plant.

In exemplary aspects, the article of manufacture comprises a plurality of solid particles mixed with a soil. In exemplary aspects, the plurality of solid particles are compressed into a solid form. In exemplary aspects, the method comprises inserting the solid particle into the soil near the plant.

The plant may be any type of plant. In exemplary embodiments, the plant is a flowering plant. In alternative embodiments, the plant is a non-flowering plant. In exemplary aspects, the plant is a conifer, gymnosperm, fern, whisk fern, horsetail, ginkgo, gnetophyte, cycad, moss, clubmoss, hornwort, liverwort, or a green algae. In exemplary aspects, the plant is a seed plant. In exemplary aspects, the plant produces a grain, fruit, or vegetable for mammalian consumption. In exemplary aspects, the plant is a grass or other type of landscape plant.

The subject may be any animal. The subject in exemplary aspects is a mammal, including, but not limited to, mammals of the order Rodentia, such as mice and hamsters, and mammals of the order Logomorpha, such as rabbits, mammals from the order Carnivora, including Felines (cats) and Canines (dogs), mammals from the order Artiodactyla, including Bovines (cows) and Swines (pigs) or of the order Perssodactyla, including Equines (horses). In some aspects, the mammals are of the order Primates, Ceboids, or Simoids (monkeys) or of the order Anthropoids (humans and apes). In exemplary aspects, the mammal is a human. In exemplary aspects, the subject is a human

In exemplary aspects, the nematode is any organism in the taxonomy order Rhabditida. In exemplary aspects, the nematode is selected from the group consisting of: Caenorhabditis elegans, Caenorhabditis remanei, Caenorhabditis sp. 7, Caenorhabditis sp. 7 (dauer), Oscheius tipulae, Oscheius carolinensis (A), Oscheius carolinensis (If), Pratylenchus penetrans, Panagrellus redivivus, Pelodera strongyloides, Nippostrongylus brasiliensis (A), Nippostrongylus brasiliensis (If), Steinernema carpocapsae (A), Steinernema carpocapsae (If), Steinernema scapterisci (If), Steinernema riobrave (If), Steinernema glaseri (A), Steinernema glaseri (If), Romanomermis iyengari (A), Romanomermis iyengari (If), Romanomermis culicivorax (A), Heterorhabditis bacteriophora, Rhabditis sp., Ascaris suum, Pristionchus pacificus, Koernia sp., Trichuris suis, and Ancylostoma ceylanicum.

In exemplary aspects, the nematode is selected from the group consisting of: Acontylus, Afenestrata, Aglenchus, Allotrichodorus, Allotylenchus, Amplimerlinius, Anguina, Antarctenchus, Antarctylus, Aorolaimus, Aphasmatylenchus, Aphelenchoides, Apratylenchoides, Atalodera, Atetylenchus, Atylenchus, Axodorylaimellus, Axonchium, Bakernema, Basiria, Basirienchus, Bellodera, Belondira, Belonolaimus, Bitylenchus, Blandicephalonema, Boleodorus, Brachydorus, Bursadera, Bursaphelenchus, Cacopaurus, Cactodera, Caloosia, Campbellenchus, Carphodorus, Cephalenchus, Chitinotylenchus, Coslenchus, Criconema, Criconemella, Criconemoides, Crossonema, Cryphodera, Cucullitylenchus, Cynipanguina, Discocriconemella, Ditylenchus, Dolichodera, Dolichodorus, Dolichorhynchus, Dorylaimellus, Duotylenchus, Ecphyadophora, Ecphyadophoroides, Epicharinema, Eutylenchus, Geocenamus, Globodera, Gracilacus, Gracilancea, Halenchus, Helicotylenchus, Hemicriconemoides, Hemicycliophora, Heterodera, Heterorhabditis amazonensis, Heterorhabditis bacteriophora, Heterorhabditis baujardi, Heterorhabditis downesi, Heterorhabditis floridensis, Heterorhabditis indica, Heterorhabditis marelatus, Heterorhabditis megidis, Heterorhabditis mexicana, Heterorhabditis taysearae, Heterorhabditis zealandica, Heterorhabditis sonorensis, Hirschmanniella, Hoplolaimus, Hoplotylus, Hylonema, Immanigula, Irantylenchus, Laimaphelenchus, Lelenchus, Longidorella, Longidorus, Loofia, Macrotrophurus, Malenchus, Meloidodera, Meloidoderella, Meloidoderita, Meloidogyne, Meloinema, Merlinius, Mesocriconema, Metaxonchium, Miculenchus, Mitranema, Monotrichodorus, Morulaimus, Mukazia, Nacobbodera, Nacobbus, Nagelus, Neodolichodorus, Neodolichorhynchus, Neopsilenchus, Neothada, Nimigula, Nothocriconema, Nothocriconemoides, Ogma, Opailaimus, Paralongidorus, Pararotylenchus, Paratrichodorus, Paratrophurus, Paratylenchus, Pateracephalonema, Phallaxonchium, Pleurotylenchus, Polenchus, Pratylenchoides, Pratylenchus, Probelondira, Pseudhalenchus, Psilenchus, Pterotylenchus, Punctodera, Quinisulcius, Radopholus, Rhizonema, Rotylenchulus, Rotylenchus, Sarisodera, Sauertylenchus, Scutellonema, Scutylenchus, Senegalonema, Siddiqia, Sphaeronema, Steinernema abbasi, Steinernema aciari, Steinernema affine, Steinernema akhursti, Steinernema anatoliense, Steinernema apuliae, Steinernema 7163906-1-162-arenarium, Steinernema ashiuense, Steinernema asiaticum, Steinernema australe, Steinernema backanese, Steinernema bedding, Steinernema biocornutum, Steinernema ceratphorum, Steinernema cholashansense, Steinernema citrae, Steinernema cubanum, Steinernema cumgarense, Steinernema diaprepsi, Steinernema eapokense, Steinernema everestense, Steinernema feltiae, Steinernema glaseri, Steinernema guangdongense, Steinernema hebeinse, Steinernema hermaphroditum, Steinernema ichnusae, Steinernema intermedium, Steinernema jollieti, Steinernema karii, Steinernema khoisanae, Steinernema kraussei, Steinernema kushidai, Steinernema leizhouense, Steinernema lici, Steinernema litorale, Steinernema longicaudatum, Steinernema monticolum, Steinernema neocurtillae, Steinernema oregonense, Steinernema pakistanense, Steinernema phyllogphagae, Steinernema puertoricense, Steinernema rarum, Steinernema riobrave, Steinernema ritteri, Steinernema robustispiculum, Steinernema sangi, Steinernema sasonense, Steinernema scapterisci, Steinernema scarabaei, Steinernema schliemanni, Steinernema siamkayai, Steinernema sichuanense, Steinernema silvaticum, Steinernema tami, Steinernema texanum, Steinernema thanhi, Steinernema websteri, Steinernema weiseri, Steinernema yirgalemense, Subanguina, Swangeria, Sychnotylenchus, Syncheilaxonchium, Telotylenchus, Tetylenchus, Thada, Thecavermiculatus, Trichodorus, Trichotylenchus, Triversus, Trophonema, Trophotylenchulus, Trophurus, Tylenchocriconema, Tylenchorhynchus, Tylenchulus, Tylenchus, Tylodorus, Verutus, Xenocriconemella, Xiphinema, and Zygotylenchus

The terms “treat,” and “prevent” as well as words stemming therefrom, as used herein, do not necessarily imply 100% or complete treatment or prevention. Rather, there are varying degrees of treatment or prevention of which one of ordinary skill in the art recognizes as having a potential benefit or therapeutic effect. In this respect, the methods can provide any amount of any level of treatment or prevention in a mammal or plant. Furthermore, the treatment or prevention can include treatment or prevention of one or more conditions or symptoms of the disease being treated or prevented. Also, for purposes herein, “prevention” can encompass delaying the onset of the infection, or a symptom or condition thereof.

The following examples merely illustrate the present disclosure and do not in any way to limit its scope.

### EXAMPLES

### Example 1

This example demonstrates predator-secreted sulfolipids induce fear-like defense responses in C. elegans.

Abstract:

Animals respond to predators by altering their behavior and physiological states, but the underlying signaling mechanisms are poorly understood. Using the interactions between Caenorhabditis elegans and its predator, Pristionchus pacificus, we show that neuronal perception by C. elegans of a predator-specific molecular signature induces instantaneous escape behavior and a prolonged reduction in oviposition. Chemical analysis revealed this predator-specific signature to consist of a class of sulfolipids, produced by a biochemical pathway required for developing predacious behavior and specifically induced by starvation. These sulfolipids are detected by four pairs of C. elegans amphid sensory neurons that act redundantly and recruit cyclic nucleotide-gated (CNG) or transient receptor potential (TRP) channels to drive both escape and reduced oviposition. Functional homology of the delineated signaling pathways and abolishment of predator-evoked C. elegans responses by the anti-anxiety drug sertraline suggests a likely conserved or convergent strategy for managing predator threats.

Introduction: Animal survival depends on the ability to sense predators and generate appropriate behavioral and physiological changes1. Such defensive behaviors2, including the commonly observed ‘flight or freezing’ responses, are often hard-wired into the genome of the prey—for example, mice reliably exhibit fear-like responses to cat odors despite not having encountered cats for hundreds of generations³. Despite this, the neuronal and signaling machinery that regulate defensive behaviors remains poorly understood. One approach to uncovering the nature of innate defensive responses is to identify the molecular signals between predators and prey and map the underlying neuronal and molecular machinery that drive defensive responses to these signals.

Studies from both vertebrates and invertebrates indicate that signaling between predators and prey involves multiple sensory modalities including vision, audition, and most frequently olfaction. Considerable progress has been made in identifying the sensory neurons that detect predator-released odors in several model systems. For example, in mice, the chemosensory neurons in the vomeronasal organ (VNO), Grueneberg ganglion, and main olfactory epithelium have been shown to facilitate defensive behaviors through detection of signals from cat urine and fox feces^{3,7,8}. These neurons project to higher brain regions where predator odor information is processed to generate stereotyped defensive behaviors². More generally, it is thought that circuit constancy typically accompanies behavioral stereotypy. While neural circuits that detect odors vary between individuals¹⁰, those sensing predator-released odors appear to be invariant between members of the same species³. However, the precise identities of the participating neurons, their connections, and the nature of the circuit computations driving these invariant defensive behaviors have remained elusive.

We approached these questions by analyzing the behavioral responses of the nematode Caenorhabditis elegans¹¹ to a predatory nematode Pristionchus pacificus¹². These two nematodes likely shared a common ancestor around 350 million years ago¹³. Recent studies have shown that P. pacificus is a facultative predator. P. pacificus can bite and kill C. elegans, a process facilitated by the extensive re-wiring of the P. pacificus nervous system under crowded and/or starvation conditions^{14,15}. C. elegans, with its fully mapped neural network comprising of just 302 neurons connected by identified synapses and powerful genetic tools, is ideally suited for a molecular and circuit-level analysis of complex behaviors^{16,17}. Combining chemical and genetic methods, we dissected the signaling circuits underlying C. elegans' responses to P. pacificus. We found that a novel class of sulfated small molecules excreted by P. pacificus trigger defensive responses in C. elegans. These P. pacificus-derived chemical signals are detected by C. elegans via multiple sensory neurons and processed via conserved signaling pathways.

Results

A Predator Elicits Defense Responses in C. elegans

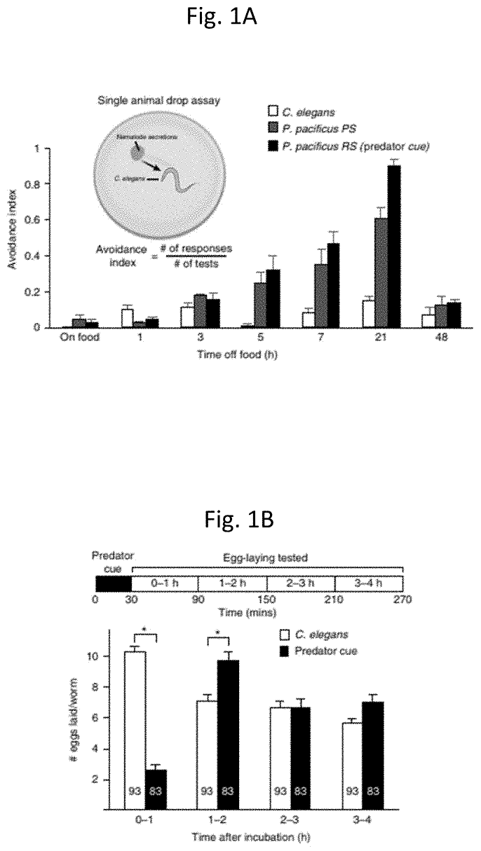

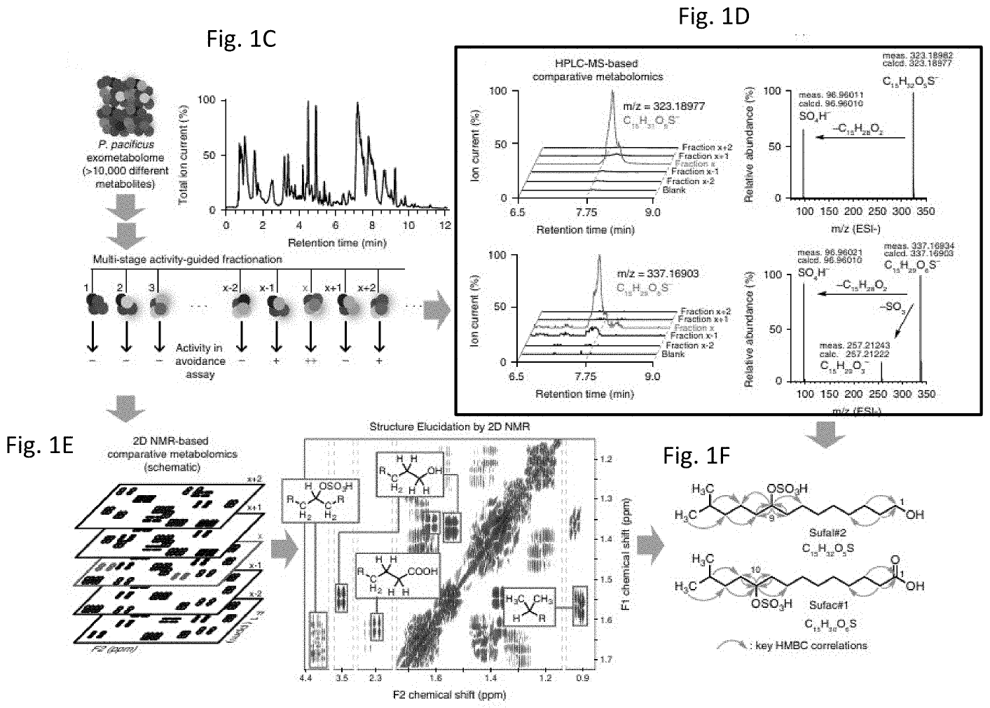

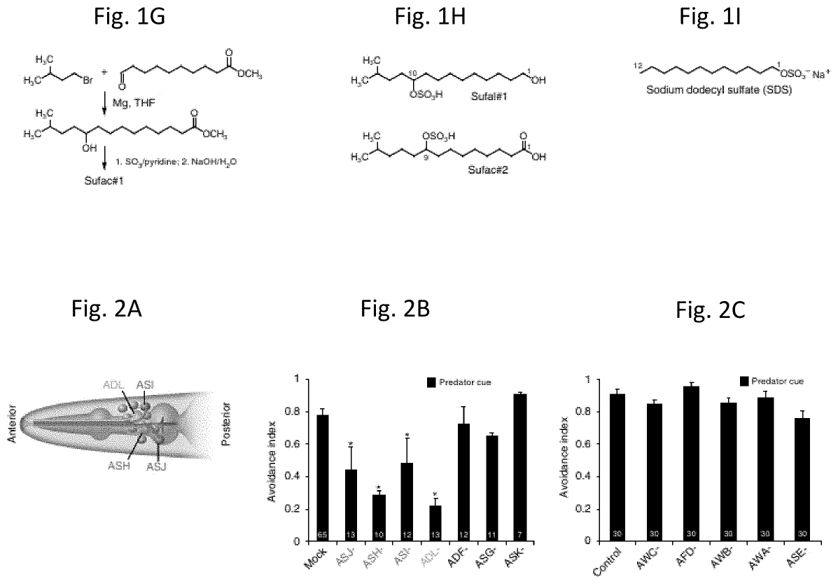

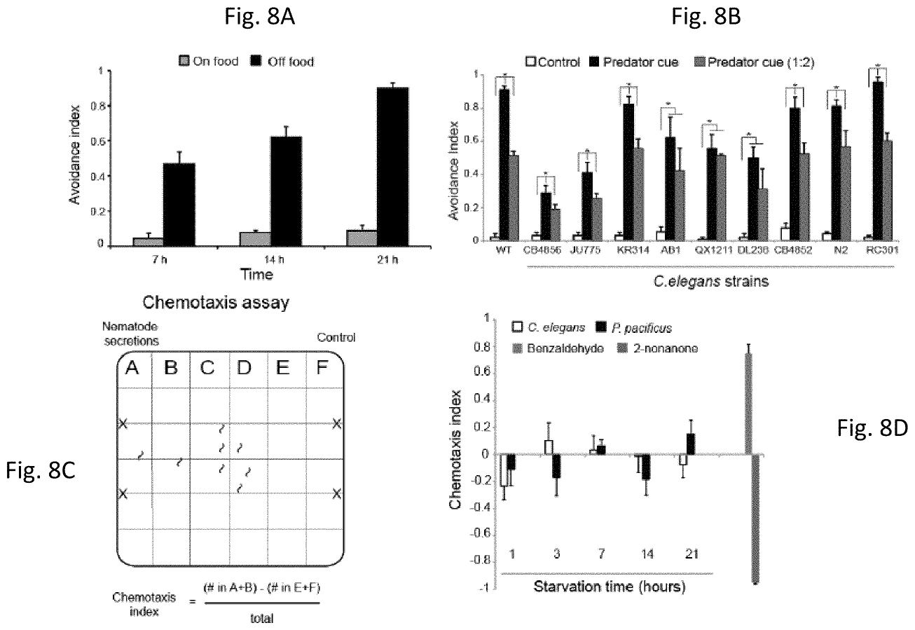

C. elegans was originally isolated from compost heaps in the developmentally arrested dauer stage¹⁸. However, recent studies have isolated proliferating and feeding populations of C. elegans from rotting flowers and fruits¹², where they are often found to cohabit with other nematodes including the Diplogastrid Pristionchus (M-A. Felix, personal communication). Previous reports have shown that the terrestrial nematode, P. pacificus can kill and consume the smaller nematode C. elegans. We hypothesized that the prey, C. elegans, detects the predator, P. pacificus, through chemical cues and thus tested C. elegans responses to P. pacificus excretions. We found that C. elegans showed immediate avoidance upon perceiving excretions of starved, but not well-fed predators (FIG. 1a and FIG. 8a). Excretions from P. pacificus collected after 21 h of starvation (‘predator cue’) were found to consistently repel genetically diverse C. elegans isolates (FIG. 8h). Next, we tested whether volatile components could be responsible for the activity of the predator cue by analyzing prey responses using a chemotaxis assay optimized for volatiles. We found that predator cue had no significant effect on C. elegans taxis responses in this assay (FIG. 8c,d), indicating that volatiles do not contribute to the activity of predator cue. Together, these results show that starving P. pacificus release potent non-volatile repellent(s) that induce rapid C. elegans avoidance.

We further found that C. elegans exposed to predator cue did not lay eggs for many minutes following exposure, even when placed on food (bacterial lawn), suggesting that predator cue-induced stress affects egg-laying behavior. Consistent with this idea, previous studies have shown that C. elegans retain eggs in the gonad when exposed to environmental stressors²¹. To test our hypothesis, we designed a behavioral assay wherein the prey was exposed to predator cue for 30 min, and egg-laying was monitored for many hours following cue removal Animals exposed to predator cue laid significantly fewer eggs than controls during the initial 60 min following cue removal. During the next hour (i.e., the 60-120 min post-cue time period), these animals laid more eggs than controls, suggesting that predator cue transiently modified egg-laying behavior, but not egg production (FIG. 1b). Collectively, these results indicate that starving P. pacificus release a potent, non-volatile factor (predator cue) that elicits multiple prey responses, namely urgent escape behavior followed by up to one hour of reduced egg laying.

Predator-Derived Sulfolipids Elicit Defense Responses

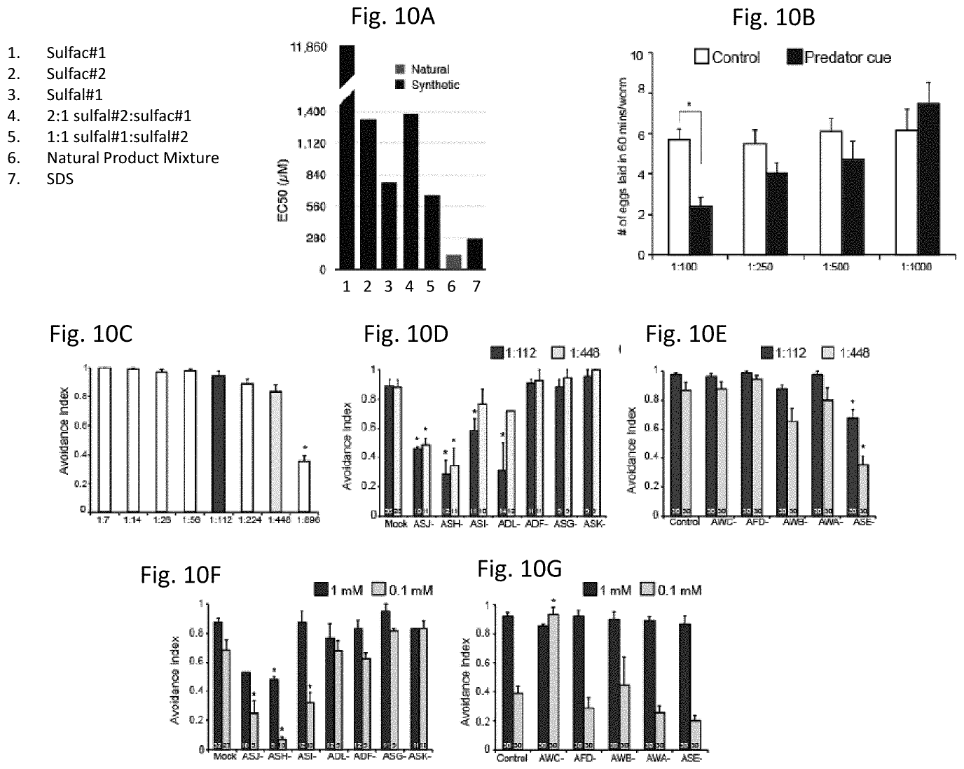

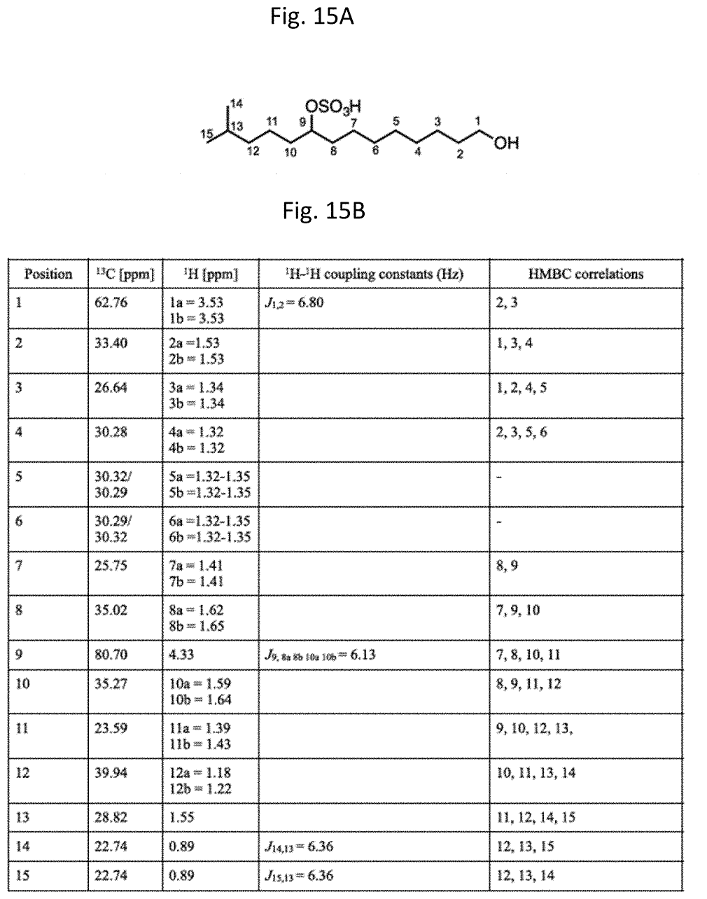

We aimed to identify the chemical structure(s) of the small molecule(s) excreted by P. pacificus that cause C. elegans avoidance behavior. As the P. pacificus exo-metabolome is highly complex, consisting of more than 20,000 distinct compounds detectable by UHPLC-HRMS (FIG. 1c), we used a multistage activity-guided fractionation scheme (see Supplementary Methods of Liu et al., Nature Communications 9: 1128 (2018)). After three rounds of fractionation, chemical complexity of individual fractions had been reduced sufficiently to enable comparative metabolomics analysis of 2D NMR spectra^{22,23} and high-resolution tandem mass spectrometry data of active and adjacent inactive fractions (FIG. 1d, e, FIGS. 15a-17d). This analysis revealed several novel (ω-1)-branched-chain sulfolipids (sufac#1, and sufal#2) as major components of active, but not inactive fractions (FIG. 1f). Further analysis revealed several additional sulfolipids with closely related structures, including sufac#2 and sufal#1, which differ in the position of attachment of the sulfate moiety (FIG. h). Next, we corroborated the structures of these compounds via total synthesis and tested their activity in the avoidance assay. The terminal alcohols sufal#1 and sufal#2 accounted for most of the isolated activity (FIG. 10a, Supplementary methods of Liu et al., Nature Communications 9: 1128 (2018)).

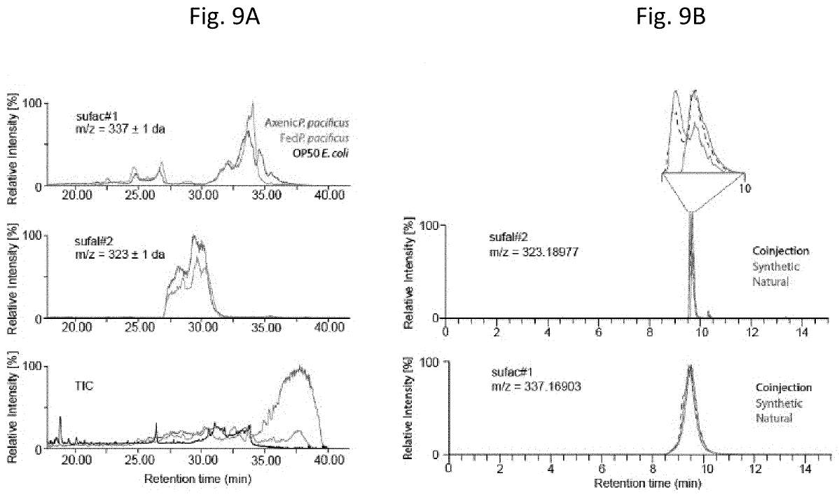

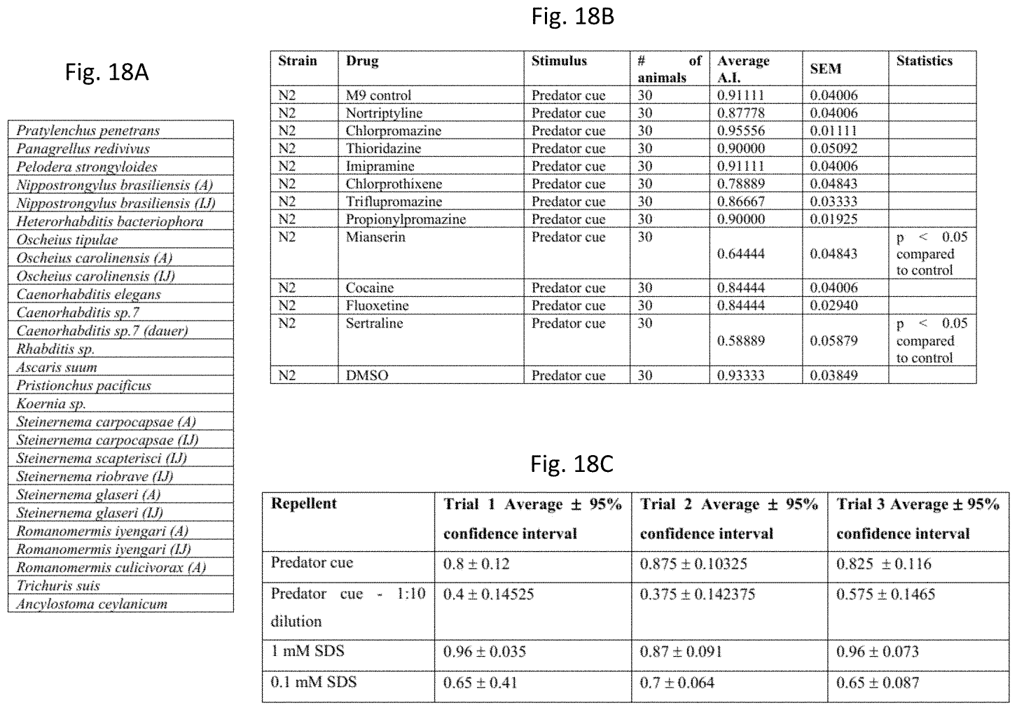

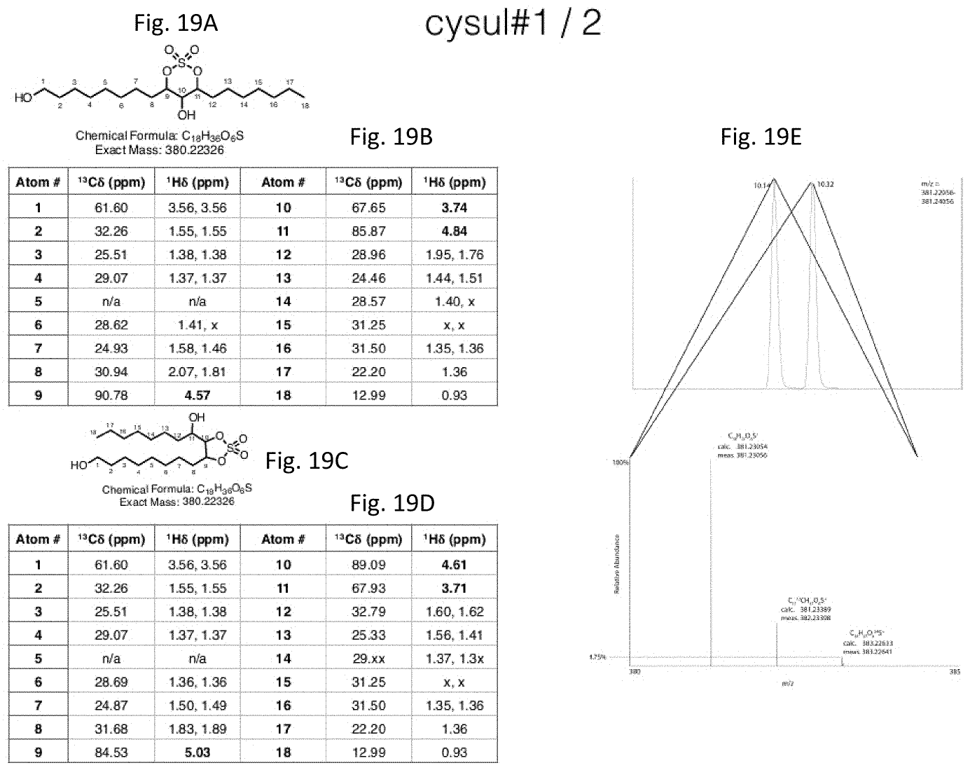

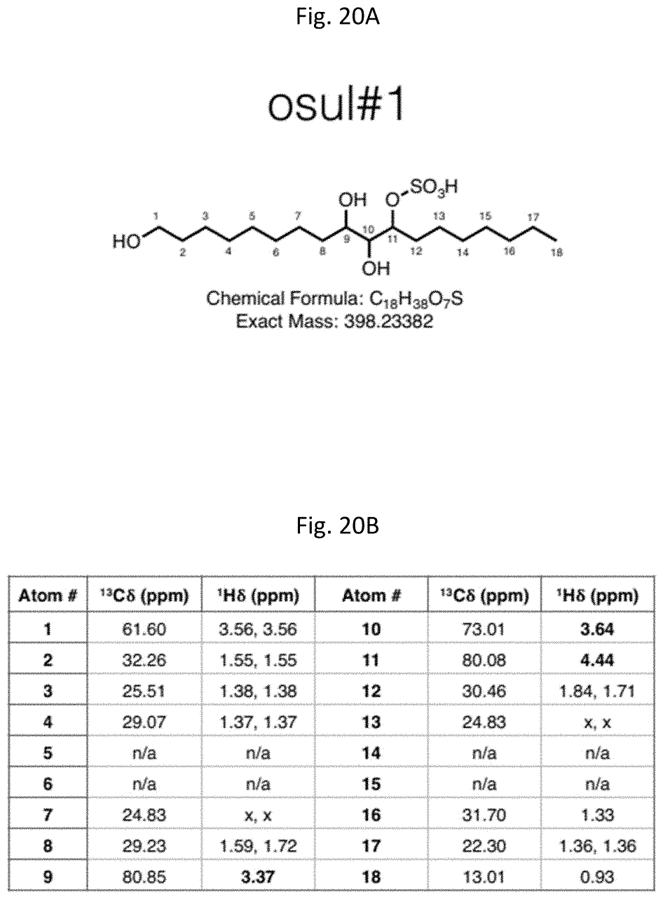

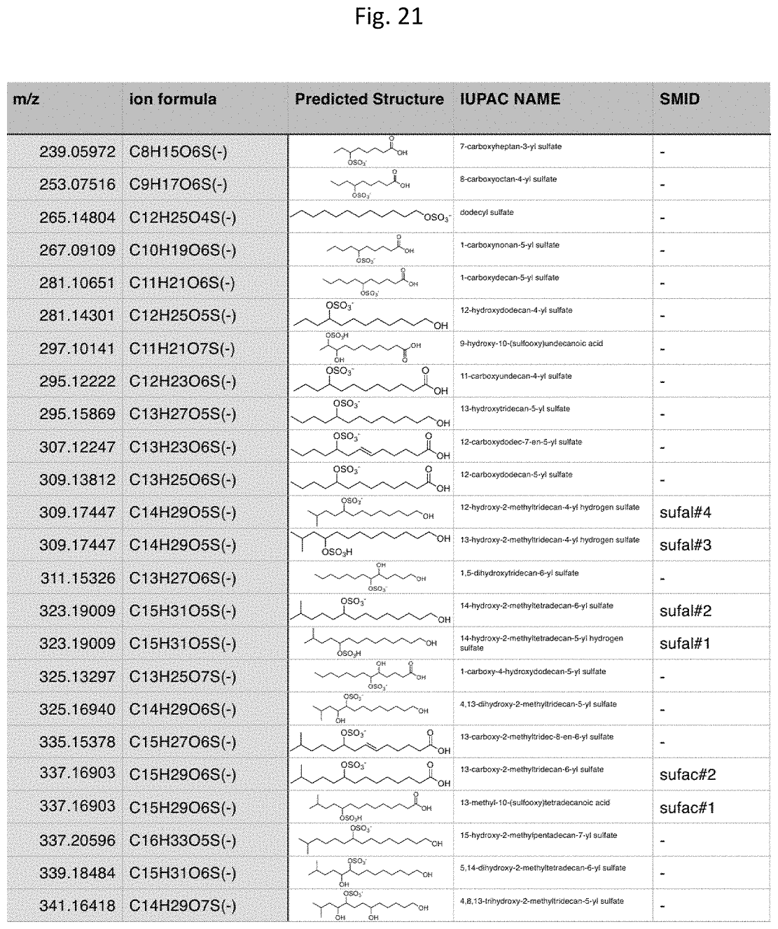

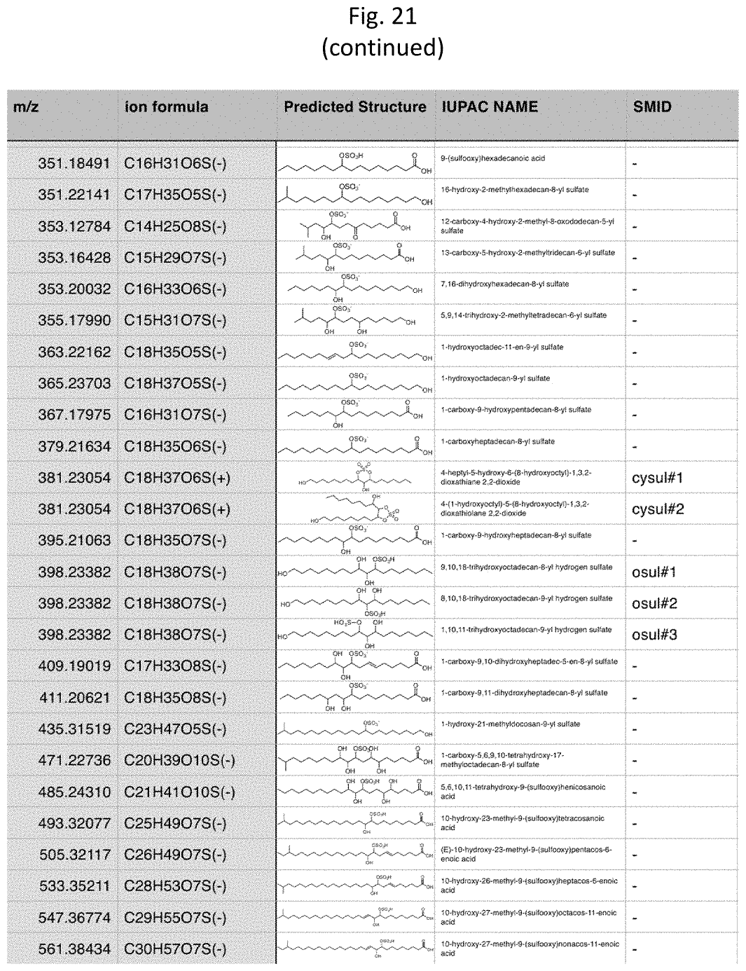

None of the identified P. pacificus sulfolipids could be detected in the metabolomes of Escherichia coli OP50 (used as food for nematodes) (FIG. 9), C. elegans, or several other nematode species (FIG. 18a), which were extracted and analyzed under identical conditions. Notably, the identified sulfolipids are structurally similar to sodium dodecyl sulfate (SDS, FIG. 1i), which is a potent C. elegans avoidance cue²⁴.

Sulfolipids are Perceived by Redundant Sensory Neurons

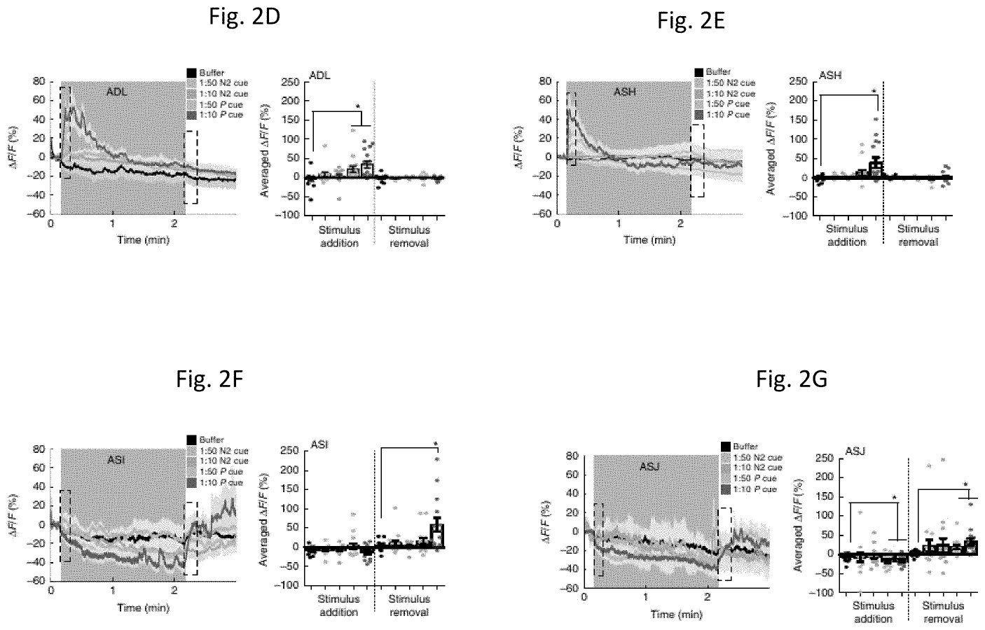

To define the prey neural circuit that detects predator cue, we tested the role of all 12 pairs of amphid sensory neurons, which project dendrites to the nose of the animal to sense environmental changes (FIG. Previous studies have shown that sensory neurons in the amphid ganglia located in the head of the worm detect repellents and generate reversals in an attempt to avoid the noxious cues²⁶. We generated animals missing each of the 12 amphid neuron pairs and tested their ability to respond to predator cue. We found that animals lacking pairs of ASJ, ASH, ASI, or ADL neurons were defective in their responses to predator cue (FIG. 2b, c), indicating that C. elegans uses multiple sensory neurons to detect predators. Responses to sulfolipids purified from predator cue and SDS were similarly reduced in animals lacking these neurons (FIG. 10f, g). In contrast, animals missing any of the other 8 neuronal pairs showed normal responses suggesting that these neurons were not required for avoidance to predator cue.

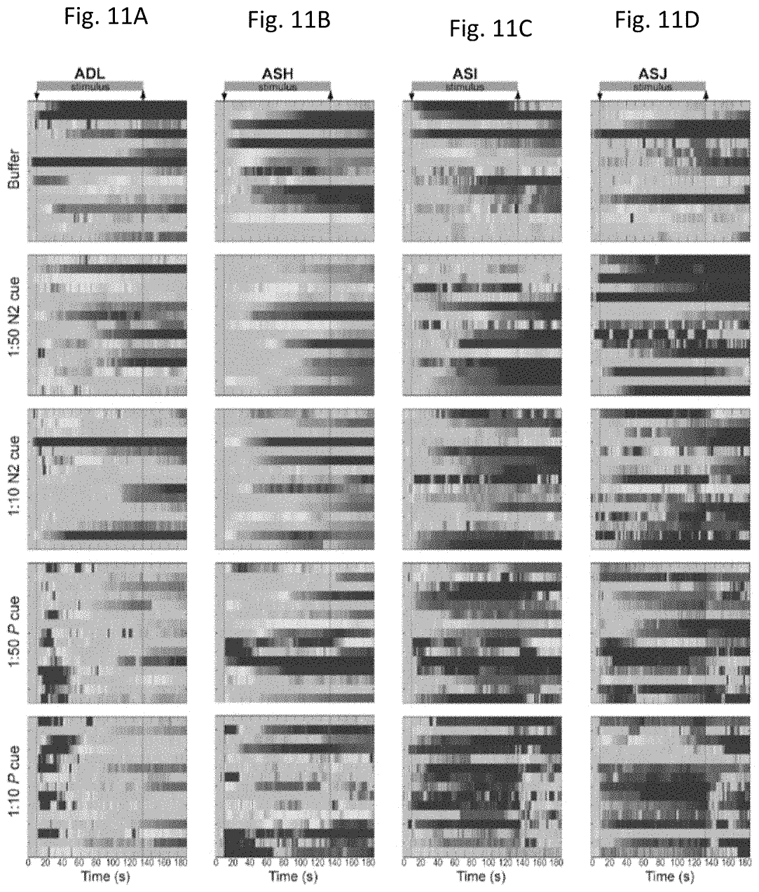

To confirm the involvement of the ADL, ASH, ASI, and ASJ neurons, we monitored their responses to predator cue using calcium imaging²⁷. Calcium responses are strongly correlated with neuronal activity in C. elegans neurons²⁸. We found that adding predator cue to the nose of the prey activated ADL and ASH (FIG. 2d, e, FIG. 11 for all traces), whereas predator cue removal activated ASI and ASJ neurons (FIG. 2f, g, FIG. 11 for all traces). Also, whereas ADL and ASJ responded to both tested dilutions of predator cue (FIG. 2d, g), ASH and ASI only detected the more concentrated cue (i.e., 1:10 dilution, but not 1:50) (FIG. 2e, f), suggesting different response thresholds for these four neuronal pairs. Collectively, these results show that addition of predator cue activates ADL and ASH neurons, whereas its removal increases ASI and ASJ activity.

C. elegans Defensive Responses Require CNG and TRP Channels

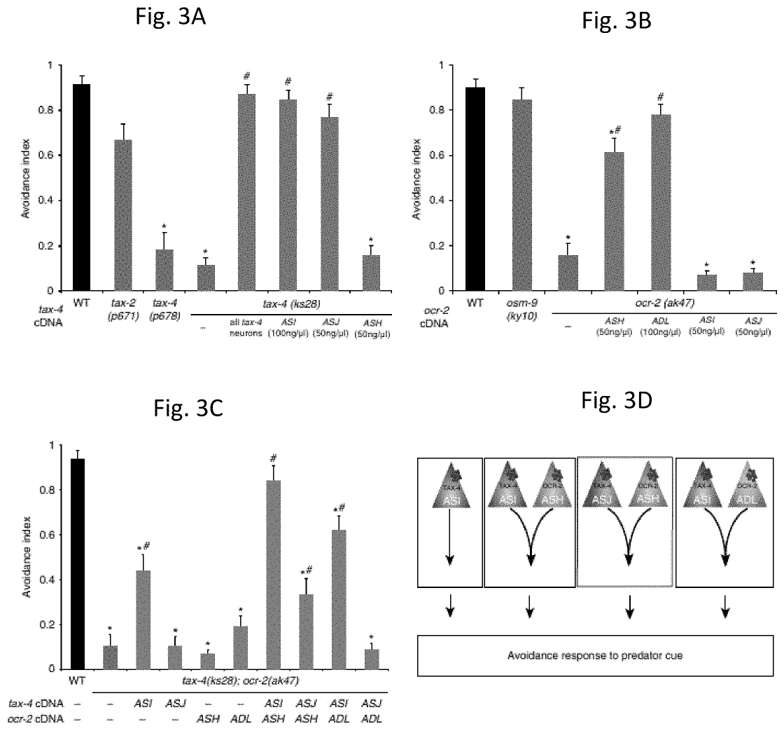

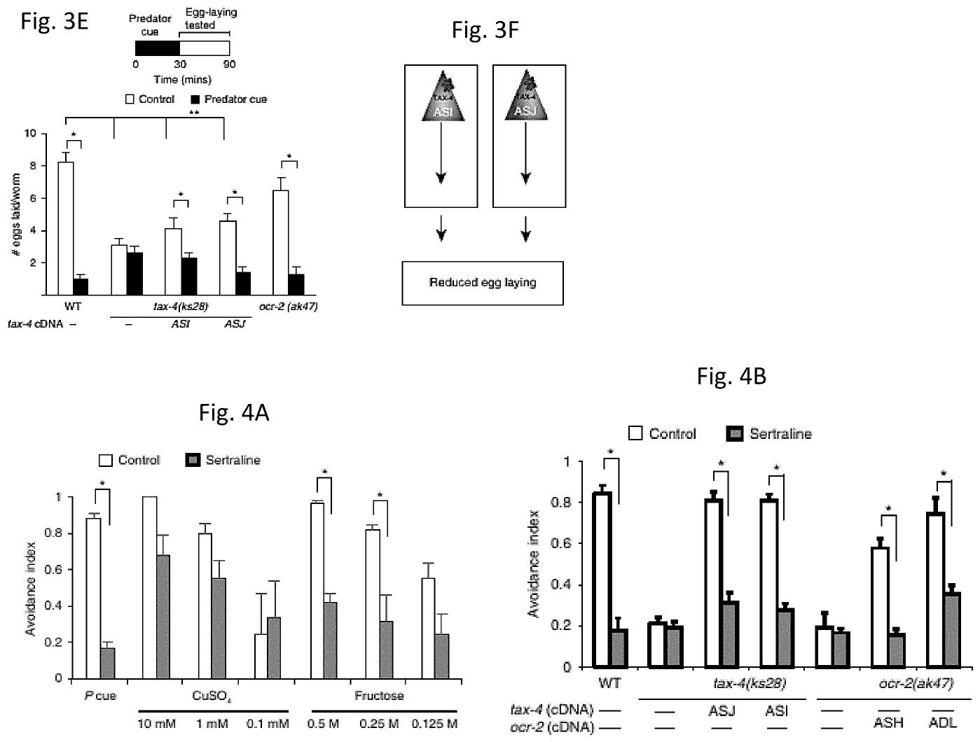

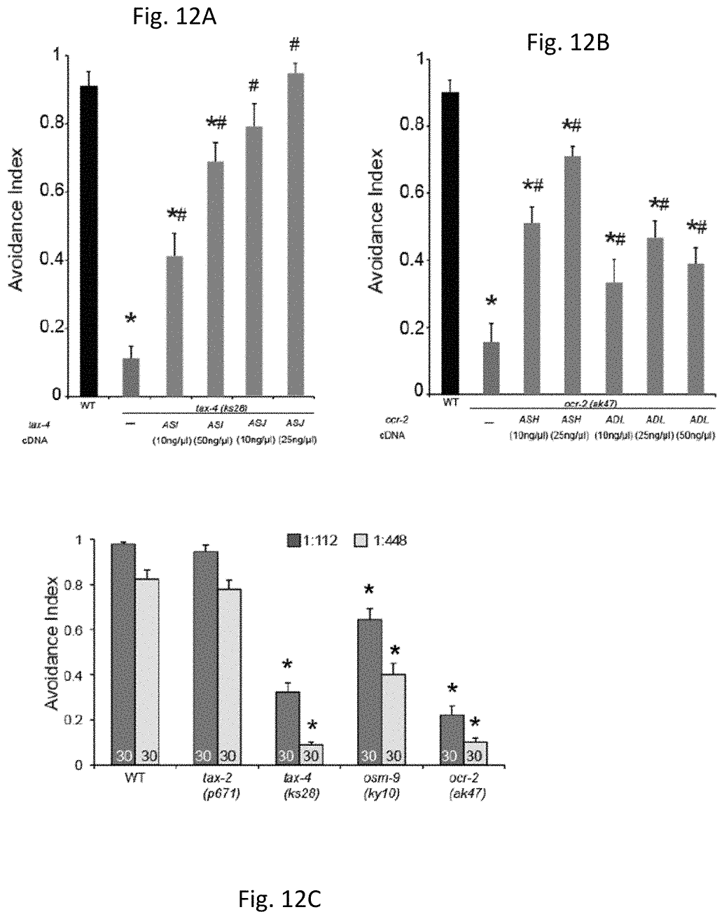

To gain insight into the signal transduction machinery underlying these responses, we examined the behavior of mutants lacking specific signaling components. We found that mutants lacking the alpha subunit (tax-4), but not the beta subunit (tax-2), of the cyclic nucleotide-gated (CNG) ion channel exhibited defective responses to predator cue (FIG. 3a). Previously, TAX-4 but not TAX-2 subunits have been shown to form a homomeric CNG channel²⁹, suggesting that TAX-4 might function in a TAX-2 independent manner. Moreover, expressing the full-length tax-4 cDNA via a tax-4 promoter, an ASI-specific promoter, or an ASJ-specific promoter (but not via an ASH-selective promoter) restored normal behavior to the null mutants (FIG. 3a) The ability of these transgenes to rescue avoidance behavior was largely dose dependent, as it varied depending on the amount of tax-4 transgene expressed in ASI and ASJ neurons (FIG. 12a). These data indicate that increased CNG signaling from ASI neurons could compensate for the lack of signaling from ASJ, and vice-versa. Collectively, these results show that TAX-4 functions in a TAX-2 independent manner in ASI and ASJ neurons to drive predator avoidance. Similarly, mutants lacking the transient receptor potential (TRP) channel OCR-2, but not OSM-9, were defective in their responses to predator cue. Further, we observed that OCR-2 functions in ADL and ASH neurons, but not in ASI or ASJ neurons (FIG. 3b), and that responses to ASH- and ADL-specific ocr-2 transgenes were also dose dependent (FIG. 12b), indicating that signaling from ASH could compensate for the lack of ADL signaling, and vice-versa. Testing samples of purified sulfolipids confirmed that tax-4 (but not tax-2) and ocr-2 (but not osm-9) mutants were defective in avoidance to these molecules (FIG. 12c). Together, these results show that OCR-2 functions in a OSM-9 independent manner in ASH and ADL neurons to generate avoidance to predator cue, results consistent with previous studies^{30,31}.

To investigate possible interactions between CNG and TRP channel signaling, we analyzed tax-4; ocr-2 double mutants. Restoring TAX-4 function to ASI neurons and OCR-2 to ASH neurons (in combination) using the highest dosage of the respective transgenes conferred normal predator cue avoidance to the double mutants (FIG. 3c). Moreover, partial avoidance was seen for other rescue combinations (TAX-4 in ASJ and OCR-2 in ASH; TAX-4 in ASI and OCR-2 in ADL, and TAX-4 in ASI alone) (FIG. 30. Together, these data indicate that there are at least four neuronal signaling pathways that can drive robust avoidance to Pristionchus cue: (1) ASI sensory neurons using TAX-4 channels; (2) ASI and ASH neurons using TAX-4 and OCR-2 channels, respectively; (3) ASJ and ASH using TAX-4 and OCR-2 channels, respectively; and (4) ASI and ADL using TAX-4 and OCR-2 channels, respectively (FIG. 3d). Similarly, we found that tax-4 mutants, but not ocr-2 mutants, did not curtail their egg-laying behavior (a longer-lasting effect) in response to predator cue, and that restoring TAX-4 function to ASI or ASJ significantly improved this tax-4 defect (FIG. 3e, f). These results show that signaling from a subset of the sensory circuitry that drives instantaneous avoidance (ASI or ASJ, but not ASH or ADL) is required to generate the long-lasting changes in egg-laying behavior.

Sertraline Acts on GABA Signaling to Block Prey Behavior

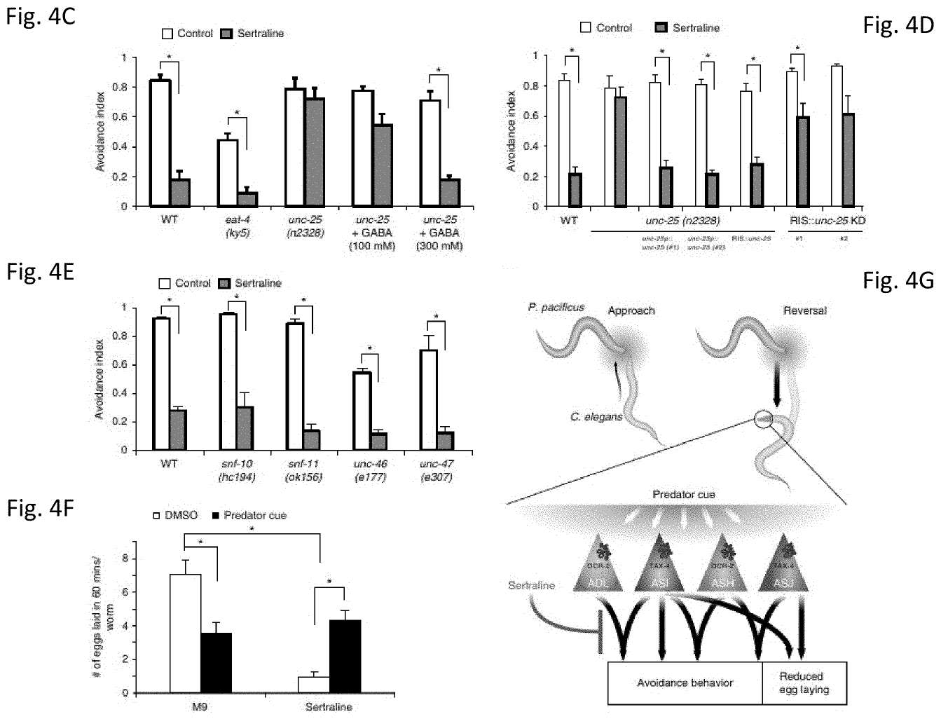

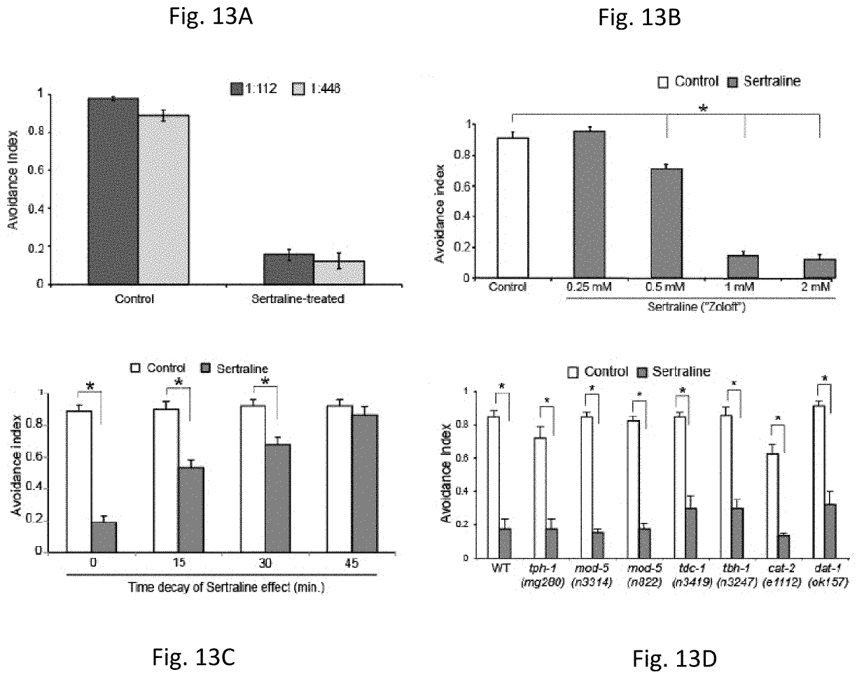

To identify signaling pathways regulating responses to predator cue, we screened a library of human anti-anxiety drugs since these compounds have previously been shown to attenuate predator-induced defensives responses in a prey³². In this screen, wild-type animals were pre-treated with different compounds for 30 min before testing their responses to predator cue. In a pilot screen of 30 compounds (FIG. 18b), we found that pre-treating prey with a selective serotonin reuptake inhibitor (SSRI), sertraline (brand name ‘Zoloft’) attenuated avoidance to predator cue and purified sulfolipids (FIG. 4a, FIG. 13a). Sertraline also attenuated avoidance responses to fructose, and, to a lesser extent, CuSO₄ (FIG. 4a), suggesting that this drug affects some, but not all repellent circuits. Suppression of avoidance behavior by sertraline was dependent on drug concentration (FIG. 13b) and lasted at least 30 min after the drug was removed (FIG. 13c). To test whether sertraline modifies signaling from specific sensory neurons, we analyzed mutants expressing different rescuing transgenes. Sertraline had no detectable effect on the behavior of tax-4 or ocr-2 mutants, but it attenuated avoidance to predator cue of tax-4 mutants expressing tax-4 in ASI or ASJ, and ocr-2 mutants expressing ocr-2 in ADL or ASH (FIG. 4h). These results indicate that sertraline likely acts downstream of CNG and TRP channels in the ASI, ASJ, ADL and ASH sensory circuits to modulate avoidance responses.

To identify relevant molecular targets of sertraline, we analyzed the behavior of gene mutants in various neurotransmitter-signaling pathways. We found that animals unable to release glutamate (eat-4, vesicular glutamate transporter³³) had reduced responses to predator cue, but showed significant sertraline-induced modulation of avoidance behavior (FIG. 4c), suggesting that glutamate was required for avoidance response, but not for the effect of sertraline on avoidance. In contrast, animals lacking glutamic acid decarboxylase (unc-25, encoding an enzyme required for GABA synthesis³⁴), but none of the other tested neurotransmitter biosynthetic enzymes were defective in sertraline attenuation (FIG. 4c, FIG. 13d). Additionally, adding GABA exogenously to the agar plate was sufficient to restore wild-type-like sertraline-evoked responses in unc-25 mutants, confirming that GABA signaling is required for sertraline-mediated attenuation of predator (FIG. 4c). These results are consistent with previous studies showing that SSRIs can modify GABA signaling without affecting serotonin levels in the mammalian brain^{35,36}, suggesting a broad conservation of the underlying signaling mechanisms.

Next, we tested whether sertraline acts on GABA signaling in specific neurons by restoring UNC-25 function using cell-specific promoters. We found that restoring UNC-25 function to all 26 GABAergic neurons³⁷ or under a RIS interneuron-selective promoter³⁸ was sufficient to restore sertraline attenuation of predator avoidance (FIG. 4d). RIS-selective unc-25 knockdowns showed normal predator avoidance, but reduced sertraline modulation, confirming RIS as the site of sertraline action (FIG. 4d). The RIS interneuron has been previously shown to play a role in inducing a sleep-like state in C. elegans^{38,39} and our results suggest an additional function for this neuron in modifying predator behavior. Efforts to identify the molecular target of sertraline were unsuccessful as mutants in the vesicular GABA transporter (unc-47), an auxiliary transport protein (unc-46), the plasma membrane GABA transporter (snf-11) or a solute carrier 6 plasma membrane reuptake transporter (snf-10) showed normal predator avoidance and sertraline modulation (FIG. 4c), indicating that sertraline acts on an unidentified target in the GABA signaling pathway. Finally, we found that sertraline treatment also reduced the longer-lasting egg-laying response (FIG. 4f) showing that the drug blocks C. elegans' responses on multiple timescales. Taken together, these results indicate that the anti-anxiety drug sertraline abolished predator-induced C. elegans responses by acting on GABA signaling in the RIS interneuron.

Discussion

We show that P. pacificus releases a mixture of sulfolipids that C. elegans perceives as a predator-specific molecular signature, or kairomone⁴⁰. Perception of these sulfolipids via multiple sensory neurons initiates defensive responses including rapid avoidance and a longer-lasting reduction in egg-laying behavior (FIG. 4g). Among the nematode species whose metabolomes we have analyzed, P. pacificus is the only one that excretes copious amounts of sulfolipids. Sulfated fatty acids and related lipids have previously been described primarily from marine sources, including tunicates⁴¹, sponges⁴², crustaceans⁴³, and algae⁴⁴. In addition, a family of sulfated fatty acids, the caeliferins, has been identified from grasshopper oral secretions^{45,46}. In a striking parallel to the role of sulfated lipids in the nematode predator-prey system studied here, these herbivore-associated sulfolipids have been shown to elicit specific defense responses in plants⁴⁶. Furthermore, the sulfolipids we identified from P. pacificus resemble sodium dodecyl sulfate (SDS), a known nematode repellent. We found that, similar to avoidance triggered by predator cue, ASJ, ASH, and ASI neurons are necessary for avoidance to SDS (FIG. 10g). Given the similarity of the neuronal circuitry required for the avoidance responses, it appears that C. elegans avoid SDS because of its structural similarity to the Pristionchus-released sulfates, which are interpreted as a molecular signature of this predator.

The sulfolipids we identified from P. pacificus, sufac#1 and sufal#2, and several related compounds, appear to be derived from the monomethyl branched-chain fatty acid (mmBCFA), C15ISO, which is also produced by C. elegans and has been shown to be essential for C. elegans growth and development⁴⁷. The biosynthesis of C15ISO in C. elegans requires the fatty acid elongase ELO-5, and several homologous elongases in P. pacificus exist that may be involved in the biosynthesis of the fatty acid precursors of sufac#1 and sufal#2. Additionally, the biosynthesis of sufac#1 and sufal#2 requires oxygenation at the (ω-5) or (ω-6) position in the fatty acid chain, respectively, followed by sulfation by sulfotransferase(s), a family of genes that has undergone major expansion in P. pacificus⁴⁸. Notably, at least one sulfotransferase, EUD-1, functions as a central switch determining whether P. pacificus larvae will develop into a primarily bacterivorous, narrow-mouthed adult, or into a predacious, wide-mouthed adult that can feed on other nematodes. It is intriguing that C. elegans has evolved the ability to detect a Pristionchus-specific trait (the extensive sulfation of small molecules) that is directly connected to the endocrine signaling pathway that controls development of the morphological features required for predation.

Detection of predator cue relies on a sensory neural circuit consisting of at least four different amphid neurons (ASI, ASH, ASJ and ADL, FIG. 4g). These neurons have well-described roles in detecting chemicals from the environment: the ASI and ASJ sensory neurons play a major role in the detection of ascaroside pheromones, whereas the ASH neurons are nociceptive and drive avoidance to glycerol and copper, and ASH and ADL act together to promote social feeding^{24,50,51,52}. Therefore, whereas ASH and ADL have previously been shown to drive avoidance behavior^{24,26}, our finding that ASI and ASJ are involved in generating avoidance is novel. Participation of these additional neurons facilitates redundancy, such that signaling from ASI, ASI and ASH, ASI and ADL, ASJ and ASH, and ASJ and ADL is sufficient to drive avoidance to predator cue. Similarly, signaling from either ASI or ASJ neurons alters egg-laying behavior, indicating that these neurons can affect C. elegans behavior on multiple timescales. We suggest that ASI and ASJ neurons encode both the removal of predator cue and some aspects of stimulus history. This enables these neurons to drive two behaviors on very different timescales: (1) a rapid avoidance when exposed to predator cue for a second and (2) a 60 min long reduced egg-laying when presented with the same predator cue for 30 min. These results are consistent with previous studies where ASI neurons have been shown to modify long-lasting behaviors⁵³. More generally, redundant circuit(s) are likely to decrease the failure rate for signaling, thereby increasing the robustness of the behavioral output. Similar redundant circuits have been described for sensory neurons detecting temperature⁵⁴ or odors⁵⁵, and in neural circuits driving feeding in the crab⁵⁶.

The neuronal signaling machinery in the ASI, ASJ, ASH and ADL sensory neurons relies on CNG and TRP channels to mediate responses to predator cue. CNG ion channels typically consist of alpha and beta subunits and have been shown to play a central role in regulating chemosensory behaviors across multiple species^{57,58}. Because the alpha subunit homolog TAX-4 is required for detecting predator cue, whereas the beta subunit TAX-2 is not, we suggest that homomeric TAX-4 channels act in the ASI and ASJ sensory neurons. In vitro experiments have shown that C. elegans TAX-4 subunits can form a functional homomeric channel when expressed in HEK293 cells²⁹. Similarly, alpha subunits of the CNG channels have also been shown to function as homomeric channels both in vitro and in vivo^{59,60}. Our studies also indicate a role for a subunit of the TRP channel OCR-2, but not its heteromeric partner OSM-9⁶¹. We suggest that OCR-2 can either form a homomeric channel or interact with other non-OSM-9 TRP channel subunits to generate a functional channel and drive avoidance behavior. These results are consistent with previous studies where OCR-2 has been shown to act independently of OSM-9 in regulating C. elegans larval starvation³⁰ and egg-laying behaviors³¹. Our results for the role of TRP channels are reminiscent of rodent studies where TRP channels have been found to play a crucial role in initiating responses to predator odors from cats³, suggesting broad conservation of the molecular machinery that detects predators. Taken together, we hypothesize that signaling from homomeric CNG and TRP channels acting in distinct, but redundant sensory circuits enable reliable detection of predators by the prey.

We further show that the anti-anxiety drug, sertraline, acts downstream of CNG and TRP channels and requires GABA signaling in RIS interneurons to suppress predator-evoked responses. Sertraline has been shown to be particularly effective in alleviating human anxiety disorders⁶² and, classified as an SSRI, is thought to act in part by elevating serotonin levels at synapses⁶³. Our studies show that sertraline requires GABA, but not serotonin signaling, to exert its effects on C. elegans avoidance behavior. Other SSRIs have also been shown to require GABA signaling in mammalian^{35,36} and C. elegans nervous systems⁶⁴, in addition to effects on other neurotransmitter pathways including dopamine, glutamate, histamine, and acetylcholine⁶⁵. We further show that sertraline action in C. elegans requires functional glutamic acid decarboxylase, a GABA biosynthesis enzyme specifically in RIS interneurons, defining the site of action of the drug. RIS interneuron have been implicated in modulating a sleep-like state in C. elegans³⁸. Previous studies have shown that RIS interneuron released neuropeptide, FLP-11 and not GABA is the major determinant of the sleep-like state³⁹. We suggest that GABA signaling in this interneuron might have a role in modulating C. elegans avoidance behaviors, particularly to external threats.

In summary, our results uncover the chemosensory and neuronal basis of a predator-prey relationship between P. pacificus and C. elegans, in which predator detection is based on a characteristic molecular signature of novel sulfate-containing molecules. The prey uses multiple sensory neurons acting in parallel and conserved CNG and TRP channel signaling to detect these sulfates and drive rapid avoidance and longer-lasting reduced egg-laying responses. Additionally, we show that sertraline acts on GABA signaling in RIS interneurons to attenuate C. elegans avoidance behavior. Based on these results, we hypothesize that C. elegans evolved mechanisms to detect Pristionchus-released sulfolipids as a kairomone, and that the identified neuronal signaling circuitry is representative of conserved or convergent strategies for processing predator threats.

### Example 2

This example describes the methods and materials used in the study of Example 1.

Calcium Imaging

Transgenic animals expressing the genetically encoded calcium indicator, GCaMP⁶⁶, under cell-selective promoters were trapped in a custom-designed microfluidic device²² and their responses to predator cue were recorded. The stimulus (predator cue) was diluted in M9 buffer (3 g KH₂PO₄, 6 g Na₂HPO₄, 5 g NaCl, 1 ml 1 M MgSO₄ per liter of water) as indicated. GCaMP imaging was performed on a Zeiss inverted microscope using a Photometrics EMCCD camera. Images were captured using MetaMorph software at 10 Hz and analyzed offline using MATLAB scripts. Baseline Fₒ was measured as the average intensity across the first 1-9 s of each recording (or 121-129 s for bar plot quantifications of the responses to stimulus removal). The ratio change in fluorescence to the baseline Fₒ is plotted in FIG. 2d-g. For bar plots shown in FIG. 2d-g, average responses in a 10 s window after stimulus addition (time 10-20 s) and a 15 s window after removal (time 130-145 s) are shown. Two-tailed unpaired t-tests were used to compare neuronal responses, and the Bonferroni correction was used to adjust for multiple comparisons. Individual traces are shown in FIG. 11.

Cell Ablations

For laser ablation experiments, worms were immobilized on agar pads containing 2% agarose with 1 mM sodium azide as anesthetic on glass slides. Individual neurons were identified using DIC optics. Cells were ablated at the L1 larval stage by focusing a laser beam focused through the objective of the microscope. The laser beam is focused in three dimensions on a single spot in the field of view of the identified neuron, specifically the nucleus of the neuron. Pulses of laser were administered and disintegration of the nucleus was monitored under DIC optics. The ablated animals were rescued from the slide and transferred to a standard NGM plate with food. The animals were allowed to recover from the procedure and assayed as young adults 72 h later. Animals with ablated neurons were tested in parallel with controls on the same day.

Chemotaxis Assay

Chemotaxis assays were performed on 2% agar square (10 cm) plates containing 5 mM potassium phosphate (pH 6), 1 mM CaCl₂, and 1 mM MgSO₄. Animals were washed three times in M9 and once in chemotaxis buffer (5 mM potassium phosphate (pH 6), 1 mM CaCl₂, and 1 mM MgSO₄) and then placed in the middle of the plate (FIG. 8c). Two spots of the collected nematode secretions and two control M9 spots (all 1 μl) were added to opposite sides of the plate, generating gradients of any volatile components in the nematode secretions Animals were allowed to explore these gradients for 1 h, after which they were counted and the chemotaxis index calculated (FIG. 8d). Benzaldehyde (1:200) and 2-nonanone (undiluted) were used as control attractants and repellents, respectively²⁵. Nine or more assays were performed on at least three different days. Two-tailed unpaired t-tests were used to compare C. elegans responses to different secretions, and the Bonferroni correction was used to adjust for multiple comparisons.

P. pacificus Predator Cue

Nematodes (C. elegans, and P. pacificus PS312 or RS5275B) were cultured on 10 cm wide NGM plates seeded with lawns of OP50 E. coli (OD₆₀₀=0 5) Animals from 40 such plates were harvested just before the bacteria were completely depleted (6 days), and washed 5 times with M9 buffer. Animals from these plates were pooled into microfuge tubes with approximately 100 μl of worms and the secretions were collected at the starvation times indicated in about 100 μl of M9 buffer. Predator Cue (RS5275B secretions) were tested and diluted in M9 buffer for further experiments. C. elegans secretions (N2 cue) were used in FIGS. 1 and 2, FIGS. 8 and 11. To further concentrate the predator cue for egg-laying assays, we passed the secretions through a Microcon 3 K Centrifugal Filter Column (Millipore), reducing the final volume to 1/10 of the initial volume. This concentrated predator cue was then used in behavioral assays.

Egg-Laying Assay

Synchronized Day 1 adults were treated with M9 control buffer or concentrated predator cue for 30 min. These animals were transferred to a 2-day lawn of 100 μl OP50 bacteria (OD₆₀₀=0.5) and allowed to lay eggs. Eggs were counted at the time intervals shown. In each condition and genotype, at least 35 animals were analyzed. Average number of eggs and s.e.m. are presented with two-tailed unpaired t-tests with Bonferroni correction for statistical analysis. To test the effect of sulfolipids on egg-laying behavior, these compounds were dissolved in DMSO and further diluted in M9 to obtain the concentrations indicated. Sertraline effects were analyzed by exposing animals to predator cue with or without sertraline (1 mM) for 30 min.

Single Animal Avoidance Assay

Adult C. elegans were exposed to a small volume of a test compound (0.05 μl) near the head of the animal Upon sensing a repellent, animals initiate a reversal followed by an omega bend. Positive responses to a test compound were scored only if they occurred within 4 s. Results are shown as the avoidance index, which is the ratio of number of positive responses to the total number of trials. Each animal is tested thrice and data is presented as average of the animals tested on at least 3 days (FIGS. 1-4 and FIGS. 8-13). For Data in FIG. 18b, animals were pre-treated with various drugs at 100 μM for 30 min and then their responses to predator cue were analyzed. Each assay was performed in triplicate (5 animals per condition) and on at least 3 different days (n<45). For Data shown in FIG. animals were pre-treated with 1 mM Sertraline (Sigma) or M9 control for 3 min before being tested for their responses in the avoidance assay. We also performed additional controls to test whether an animal's response to the three repellent trials were independent. We exposed wild-type C. elegans to two dilutions of predator cue and SDS and found that in each of these experiments (n>24) the responses were independent (data is presented in FIG. 18c), which allowed us to pool our data.

Two-tailed unpaired t-tests were used to compare different strains, genotypes, and conditions, and the Bonferroni correction was used to adjust for multiple comparisons. Avoidance indices of all strains tested and controls are shown in Supplementary Table S7 of Liu et al., Nature Communications 9: 1128 (2018)).

Nematode Strains and Molecular Biology

cDNAs corresponding to the full-length coding sequence for TAX-4 and OCR-2 were obtained from the Bargmann and Liedke labs, respectively. These constructs were sub-cloned under str-3, srh-11, sra-6, and sre-1 promoters to achieve ASI, ASJ, ASH, and ADL cell-specific expression^{67,68}. Transgenic animals were generated by injecting⁶⁹ appropriate genotypes with a mixture of the rescuing construct along with co-injection markers as described in Supplementary Table S8 of Liu et al., Nature Communications 9: 1128 (2018)).

Nematode-Derived Modular Metabolite (NDMM) Nomenclature

Nematode metabolites are named using Small Molecule IDentifiers (“SMIDs”), representing searchable, gene-style identifiers that consist of four lower case non-italicized letters followed by a pound sign and a number. The SMID database (at the world wide web (www) dot “smid-db.org”) is an electronic resource maintained by Profs. Frank C. Schroeder and Lukas Mueller at the Boyce Thompson Institute/Cornell University, in collaboration with Prof. Paul Sternberg at Caltech and WormBase (at the world wide web (www)dot “wormbase.org”). This database catalogs newly identified nematode small molecules, assigns a unique four-letter SMID (a searchable gene-style identifier), and for each compound includes a list of other names and abbreviations used in the literature.

Instrumentation for Chemical Analyses

NMR spectra were recorded on a Bruker AVANCE III HD (800 MHz) and Varian INOVA-600 (600 MHz) instruments. UHPLC-high-resolution mass spectrometry (HRMS) was performed using a Thermo Scientific Dionex Ultimate 3000 UHPLC system equipped with an Agilent ZORBAX Eclipse XDB C18 column, connected to a Thermo Scientific Q Exactive HF Hybrid Quadrupole-Orbitrap mass spectrometer. HPLC-MS and -MS/MS was performed using an Agilent 1100 Series HPLC system equipped with a diode array detector and an Agilent Eclipse XDB-C18 column (4.6×250 mm, 5 μm particle diameter), connected to a Quattro II spectrometer (Micromass/Waters). Flash chromatography was performed using a Teledyne ISCO CombiFlash system. Preparative HPLC separation was performed using the Agilent 1100 Series HPLC system equipped with an Agilent Eclipse XDB-C18 or C8 column (9.4×250 mm, 5 μm particle diameter) coupled to a Teledyne ISCO Foxy 200 fraction collector.

HPLC-MS/MS Analyses

A 0.1% acetic acid water-acetonitrile solvent gradient was used at a flow rate of 1 ml/min, starting with an acetonitrile content of 5% for 5 min and increasing to 100% over a period of 40 min. Exo-metabolome fractions were analyzed by HPLC-ESI-MS in negative and positive ion modes using a capillary voltage of 3.5 kV and a cone voltage of −35 V and +20 V, respectively. The analytical HPLC protocol mentioned above was translated to a semi-preparative Agilent Eclipse XDB-C18 or C8 column (9.4×250 mm, 5 μm particle diameter) with a flow rate of 3.6 ml/min and used for MS-assisted enrichment of desired metabolites, as well as for synthetic sample purification. Data acquisition and processing for the HPLC-MS was controlled by Waters MassLynx software.

UHPLC-HRMS Analyses

A 0.1% formic acid water −0.1% formic acid acetonitrile solvent gradient was used at a flow rate of 0.500 ml/min, starting with an acetonitrile content of 5% for 1.9 min, increasing to 100% over a period of 11 min, and then returning to 5% for 2 min. Data acquisition and processing for the UHPLC-HRMS was controlled by Thermo Scientific Xcalibur software.

P. pacificus Strains and Culture Conditions

RS2333 was used for exo-metabolome preparation. Mixed stage worms from a populated 10 cm NGM agar plate seeded with E. coli OP50 were washed into 25 ml of S-complete medium and fed OP50 on days 1, 3 and 5 for a 7-day culture period, while shaking at 22° C., 220 r.p.m. The cultures were then centrifuged and worm pellets and supernatant frozen separately. For axenic cultures, P. pacificus (RS2333) gravid adults from ten 10 cm plates were washed with M9 buffer and treated with alkaline hypochlorite solution to isolate eggs. Isolated eggs were washed thoroughly with M9 buffer and allowed to hatch in fresh sterile M9 for 24 h. The M9 supernatant was prepared as described below.

Preparation of Exo-Metabolome Extracts and Fractionation

Protocol a

P. pacificus RS2333 liquid culture supernatant (31) was lyophilized to a fine powder and extracted with 750 ml of a 95:5 mixture of ethanol and water for 16 h (2 times). The exo-metabolome extract was then concentrated in vacuo, loaded onto 12 g of ethyl acetate-washed Celite and fractionated using a Teledyne ISCO CombiFlash system and a RediSep GOLD 30 g HP C18 reverse-phase column using a water-methanol solvent gradient, starting with 15 min of 98% water, followed by a linear increase of methanol content up to 100% at 60 min. The eluate was divided into 8 fractions, which were evaporated in vacuo and prepared for HPLC-MS/MS and NMR spectroscopic analyses. Subsequently a subset of fractions was further fractionated by HPLC. A 0.1% acetic acid water-acetonitrile solvent gradient was used at a flow rate of 3.6 ml/min, starting with an acetonitrile content of 5% for 5 min and increasing to 100% over a period of 40 min.

Protocol B

P. pacificus RS2333 liquid culture supernatant (3 l) was lyophilized to a fine powder and extracted with 31 of a 95:5 mixture of ethanol and water for 16 h with stirring. The exo-metabolome extract was then concentrated in vacuo, loaded onto 8 g of ethyl acetate-washed Celite and fractionated using a Teledyne ISCO CombiFlash system over a RediSep and GOLD 100 g HP C18 reverse-phase column using a water (0.1% acetic acid)-acetonitrile solvent gradient, starting with 10 min of 100% water, followed by a linear increase of methanol content up to 100% at 92 min, which was maintained up to 100.7 min, thereby producing ˜240 fractions, which were prepared for analysis by UHPLC-HRMS.

Chemical Syntheses

General Methods for Chemical Synthesis

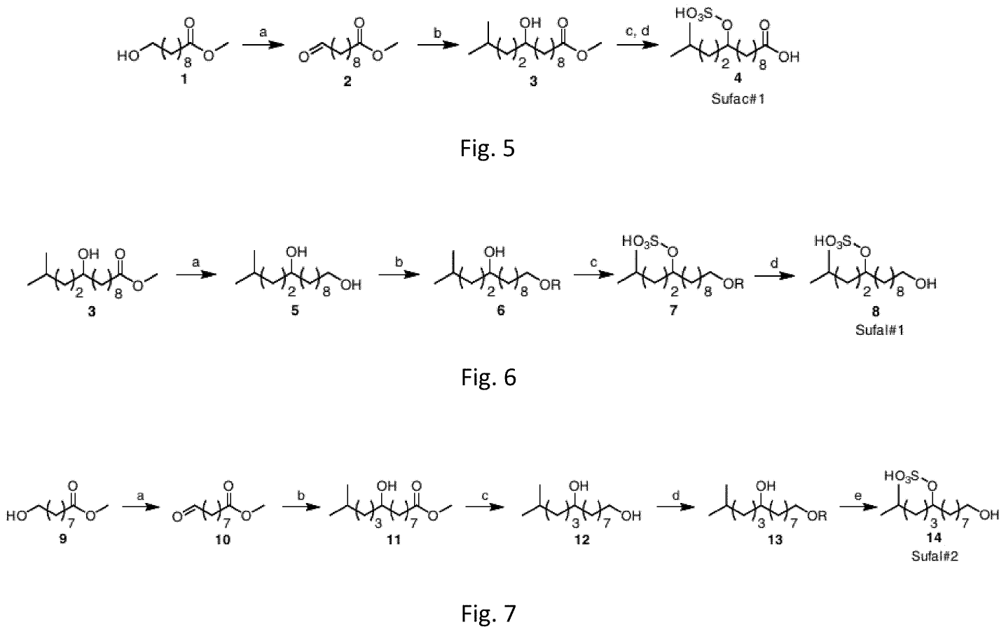

Thin-layer chromatography (TLC) was used to monitor progress of reactions unless stated otherwise, using J. T. Baker Silica Gel IB2-F. Unless stated otherwise, reagents were purchased from Sigma-Aldrich and used without further purification. N,N-dimethylformamide (DMF) and dichloromethane (DCM) were dried over 4 Å molecular sieves prior to use. Tetrahydrofuran (THF) was distilled over lithium aluminum hydride prior to use. Optical rotations were measured on a Perkin Elmer 341 polarimeter. Synthetic schemes are shown in FIGS. 5, 6, 7.

### Preparation of 2 (methyl 10-oxo-decanoate)

1 (2.5 mL, 13.5 mmol) was added to a solution of pyridinium chlorochromate (2.91 g, 13.51 mmol) and DCM (50 ml) at 0° C. After stirring for 20 min, the reaction was quenched with ether (30 ml), filtered over Celite, and washed further with ether (20 ml). The filtrate was concentrated in vacuo. Flash column chromatography on silica using a gradient of 0-100% ethyl acetate in hexanes afforded 2 at 52% purity (48% dimer) (226.12 mg, 1.13 mmol, 8%). ¹H NMR (400 MHz, chloroform-d): 8 (p.p.m.) 9.76 (t, J=2.0 Hz, 1H), 3.56 (s, 3H), 2.42 (td, J=7.4, 1.6 Hz, 2H), 2.30 (t, 7.6 Hz, 2H), 1.55-1.48 (m, 4H), 1.25-1.19 (m, 10H).

### Preparation of 3 (methyl 10-hydroxy-13-methyltetradecanoate)

Ethylene dibromide (2 drops, 0.58 mmol) was added to Mg turnings (729 mg, 30 mmol) in THF (5 ml) under argon and the mixture was heated briefly until reflux. After cooling to room temperature, a solution of 3-methylbromobutane (1.2 ml, 10 mmol) in THF (10 ml) was added dropwise to the reaction over 10 min with stirring. The reaction was stirred at reflux for 1 h, affording isopentylmagnesium bromide. The isopentylmagnesium bromide solution (100 μl, 0.9 mmol) was then added to a solution of 2 (175 mg, 874 μmol) in THF (1 ml) at −25° C. The reaction was allowed to return to room temperature while stirring, at which point the reaction was quenched with saturated NH₄Cl (10 ml) and extracted with hexanes (10 ml). Flash column chromatography on silica using a gradient of 0-100% ethyl acetate in hexanes afforded 3 at 70% purity (90.6 mg, 333 μmol, 38%). ¹H NMR (600 MHz, chloroform-d): δ (p.p.m.) 3.66 (s, 3H), 3.55 (m, 1H), 2.30 (t, 7.7 Hz, 2H), 1.64-1.32 (m, 9H), 1.20 (m, 1H), 1.30 (m, 10H), 0.90 (d, 6.6 Hz, 3H), 0.89 (d, 6.6 Hz, 3H).

### Preparation of 4 (13-methyl-10-(sulfooxy)tetradecanoic acid) (sufac#1)

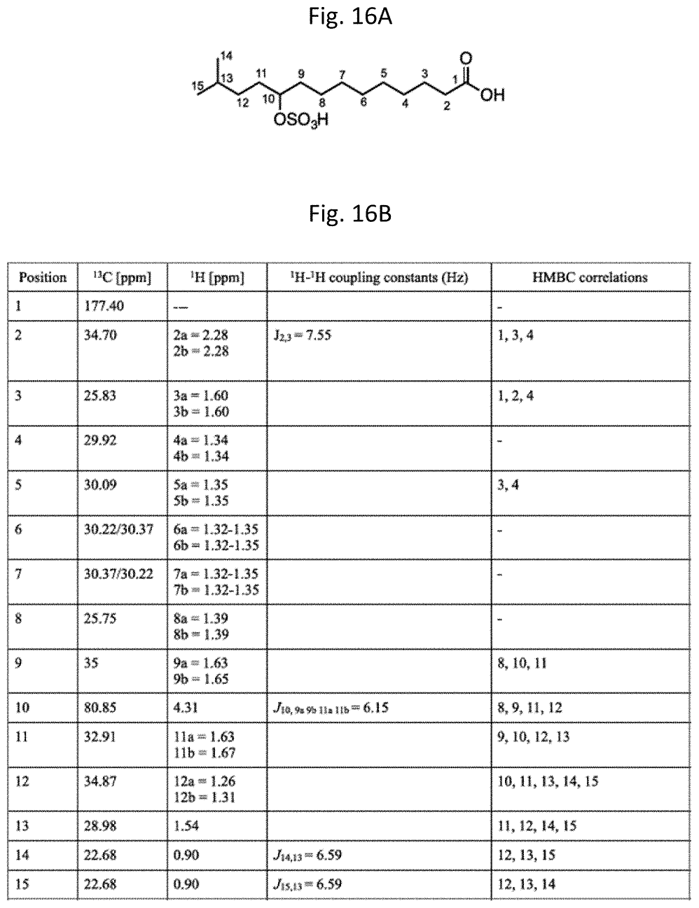

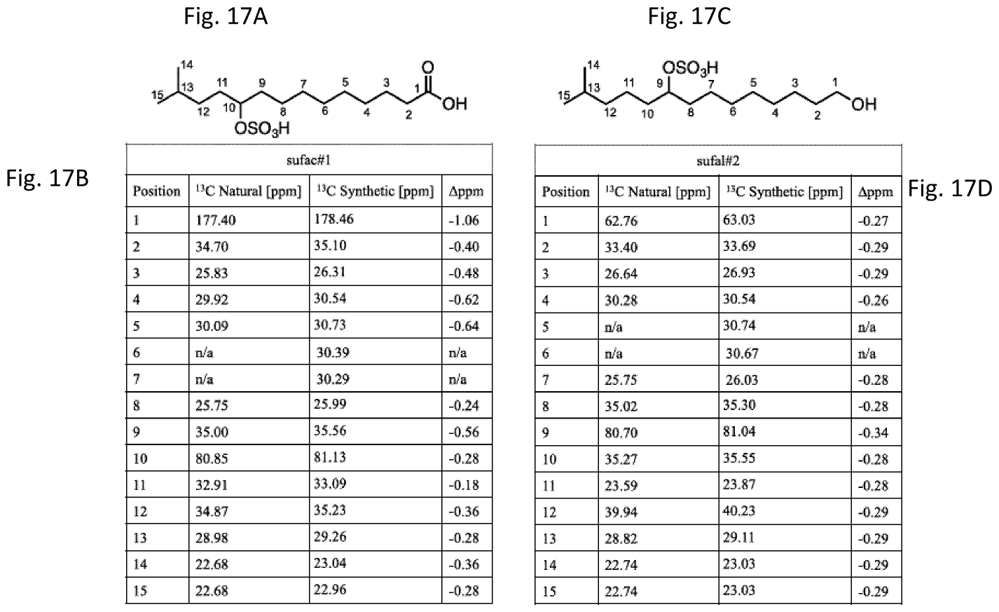

Sulfur trioxide-pyridine complex (120 mg, 0.75 mmol) was added to a solution of 3 (70 mg, 257 μmol) and pyridine (1 ml). After stirring for 5 min, the solution was concentrated in vacuo and dissolved in NaOH (aq) (4 ml, 2.75 M). The reaction was then neutralized with acetic acid/TFA to a pH of 4 and concentrated in vacuo over Celite. Flash column chromatography on silica using a gradient of 0-100% methanol in DCM afforded 4 (9.6 mg, 30 μmol, 12%). Spectroscopic data were in agreement with those for the natural product (see FIGS. 16a-17d).

### Preparation of 6 (14-((t-butyldiphenylsilyl)oxy)-2-methyltetradecan-5-ol)

TBDPSCl (30 μL, 0.11 mmol, −3 eq) was added incrementally over the course of 24 h to a solution of 5 (10.2 mg, 40 μmol) and imidazole (3.51 mg, 0.13 mmol, −3 eq) in THF (2 ml). The reaction was concentrated in vacuo. Flash column chromatography on silica using a gradient of 0-100% ethyl acetate in hexanes afforded 6 at 54% purity (6.04 mg, 12.96 μmol, 32.4%). ¹H NMR (600 MHz, methanol-d₄: δ (p.p.m.) 7.72 (m, 4H), 7.36 (m, 6H), 3.66 (t, 6.4, 2H), 3.48 (m, 1H), 1.57-1.25 (m, 20H), 1.2 (m, 1H), 1.03 (s, 9H), 0.90 (d, 6.6 Hz, 3H), 0.89 (d, 6.6 Hz, 3H).

### Preparation of 7 (14-((t-butyldiphenylsilyl)oxy)-2-methyltetradecan-5-yl hydrogen sulfate)

Sulfur trioxide-pyridine complex (excess) was added to a solution of δ(6.04 mg, 12.96 μmol) in pyridine (1 ml) and stirred for 5 min at room temperature. The reaction was concentrated in vacuo. Flash column chromatography on silica using a gradient of 0-100% methanol in DCM afforded 7 at 20% purity (3.3 mg, 6 μmol, 46% yield). ¹H NMR (600 MHz, methanol-d4): δ (p.p.m.) 7.72 (m, 4H), 7.36 (m, 6H), 4.31 (quin, 6.08 Hz, 1H), 3.66 (t, 6.4 Hz, 2H), 1.70-1.60 (m, 4H), 1.6-1.5 (m, 3H), 1.47-1.22 (m, 14H), 1.03 (s, 9H), 0.90 (d, 6.6 Hz, 3H), 0.89 (d, 6.6 Hz, 3H).

### Preparation of 8 (14-hydroxy-2-methyltetradecan-5-yl hydrogen sulfate) (sufal#1)

Methanol (500 μl) with a catalytic amount of acetyl chloride (0.5 μl) was added to a solution of 7 (1.3 mg, 2.3 μmol). The solution was concentrated in vacuo. Flash column chromatography on silica using a gradient of 0-100% methanol in DCM afforded 8 (648 μg, 2.0 μmol, 87% yield). Spectroscopic data were in agreement with those for the natural product: ¹H NMR (600 MHz, methanol-d4): δ (p.p.m.) 4.31 (quin, 6.1 Hz, 1H), 3.54 (t, 6.8 Hz, 2H), 1.7-1.58 (m, 5H), 1.57-1.49 (m, 3H), 1.47-1.23 (m, 13H), 0.91 (d, 6.6 Hz, 3H), 0.90 (d, 6.6 Hz, 3H); ¹³C NMR (800 MHz, methanol-d₄): δ (p.p.m.) 62.76, 33.40, 26.64, 30.28, 30.xx, 30.xx, 30.xx, 25.75, 35.00, 80.85, 32.91, 34.87, 28.98, 22.68, 22.68

### Preparation of 10 (methyl-9-oxo-nonanoate)

9 (600 μl, 2.8 mmol) was added to a solution of PCC (900 mg, 4.2 mmol) in dry DCM (50 ml) under argon at −15° C., and the mixture was stirred for 45 min. Reaction progress was monitored by TLC. The reaction mixture was allowed to return to room temperature and was stirred for an additional 40 min. The mixture was then filtered over Celite, and the residue was washed with ether. The filtrate was concentrated in vacuo. Flash column chromatography on silica using a gradient of 0-100% ethyl acetate in hexanes afforded 10 at 70% purity (containing about 30% starting material) (305 mg, 1.64 mmol, 58% yield). ¹H NMR (600 MHz, chloroform-d): δ (p.p.m.) 9.76 (t, 1.79 Hz, 1H), 3.66 (s, 3H), 2.42 (td, 7.30, 1.77 Hz, 2H), 2.30 (t, 7.60 Hz, 2H), 1.62 (m, 4H), 1.32 (m, 6H).

### Preparation of 11 (methyl 9-hydroxy-13-methyltetradecanoate)

Ethylene dibromide (6 drops, 1.74 mmol) were added to Mg turnings (500 mg, 20.6 mmol, −2 eq) in THF (5 ml) under argon. And the mixture was heated to reflux for 20 min. After cooling to room temperature, 4-methylbromopentane (1.38 ml, 10 mmol) in THF (10 ml) was added quickly to the solution of activated Mg turnings. The mixture was then refluxed for 1 h. After cooling to room temperature, the Grignard reagent (1.36 ml, 0.9 mmol, 1 eq) was added to a solution of 10 (170 mg, 0.9 mmol) in THF (1 ml). The reaction was monitored by TLC using 1:4 acetone:hexanes. The reaction was quenched with saturated NH₄Cl (10 ml) and extracted with hexanes. Flash column chromatography on silica using a gradient of 0-100% ethyl acetate in hexanes afforded 11 at 60% purity (81.7 mg, 0.3 mmol, 32%). ¹H NMR (400 MHz, chloroform-d): (p.p.m.) 3.66 (s, 3H), 3.58 (m, 1H), 2.30 (t, 7.58 Hz, 2H), 1.65-1.49 (m, 4H), 1.47-1.36 (m, 4H), 1.31 (m, 9H), 1.16 (m, 1H), 0.88 (d, 6.64 Hz, 3H), 0.88 (d, 6.64 Hz, 3H).

### Preparation of 12 (13-methyltetradecane-1,9-diol)

11 (81.7 mg, 300 μmol) was added dropwise to a suspension of lithium aluminum hydride (102.3 mg, 2.69 mmol) in THF (20 ml) at 0° C. The solution was warmed slowly to room temperature while stirring for 20 min. The reaction was quenched by the Fieser method as described above, filtered over Celite, and concentrated in vacuo. Flash column chromatography on silica using a gradient of 0-100% ethyl acetate in hexanes afforded 12 at 90% purity (57.0 mg, 234 μmol, 77.4%). ¹H NMR (400 MHz, methanol-d₄): δ (p.p.m.) 3.54 (t, 6.53 Hz, 2H), 3.50 (m, 1H), 1.61-1.13 (m, 21H), 0.89 (d, 6.6 Hz, 3H), 0.89 (d, 6.6 Hz, 3H).

### Preparation of 13 (14-((tert-butyldiphenylsilyl)oxy)-2-methyltetradecan-6-ol)

TBDPS-Cl (97.6 μl, 370 μmol) was added incrementally over the course of 3 h to a solution of 12 (57.0 mg, 234 μmol) in THF (1 ml) and DMF (0.5 ml). The reaction was concentrated in vacuo. Flash column chromatography on silica using a gradient of 0-100% ethyl acetate in hexanes afforded 13 at 30% purity (13.1 mg, 23.4 μmol, 10%). ¹H NMR (400 MHz, methanol-d4): δ (p.p.m.) 7.67-7.64 (m, 4H), 7.41-7.35 (m, 6H), 3.66 (t, 6.1 Hz, 2H), 3.50 (m, 1H), 1.61-1.13 (m, 21H), 1.03 (s, 9H), 0.89 (d, 6.6 Hz, 3H), 0.89 (d, 6.6 Hz, 3H).

### Preparation of 14 (14-hydroxy-2-methyltetradecan-6-yl hydrogen sulfate) (sufal#2)

Sulfur trioxide-pyridine complex (50 mg, excess) was added to a solution of 13 (20 μmol) in acetonitrile (2 ml). The solution was concentrated in vacuo. Flash column chromatography on silica using a gradient of 0-100% methanol in DCM afforded 14 (0.65 mg, 2 μmol, 10%). Spectroscopic data were in agreement with those for the natural product (see FIGS. 15a-17d).

Data Availability

Data presented herein is also published as Liu et al., Nature Communications 9: 1128 (2018) or maintained with the authors. Sulfolipid structures have been deposited to the Metabolights database, Study Identifier MTBLS611 (at “https://” world wide web (www)dot “ebi.ac.uk/metabolights/MTBLS611”).

### Example 3

This example describes the testing of the avoidance index exhibited by different species to sulfolipids at varied ratios.

Adult nematodes were exposed to a small volume of a test compound (0.05 μl) near the head of the animal. Upon sensing a repellent, animals initiate a reversal followed by an omega bend. Positive responses to a test compound were scored only if they occurred within 4 s. Results are shown as the avoidance index, which is the ratio of number of positive responses to the total number of trials. Each animal is tested thrice and data is presented as average of the animals tested on at least 3 days.

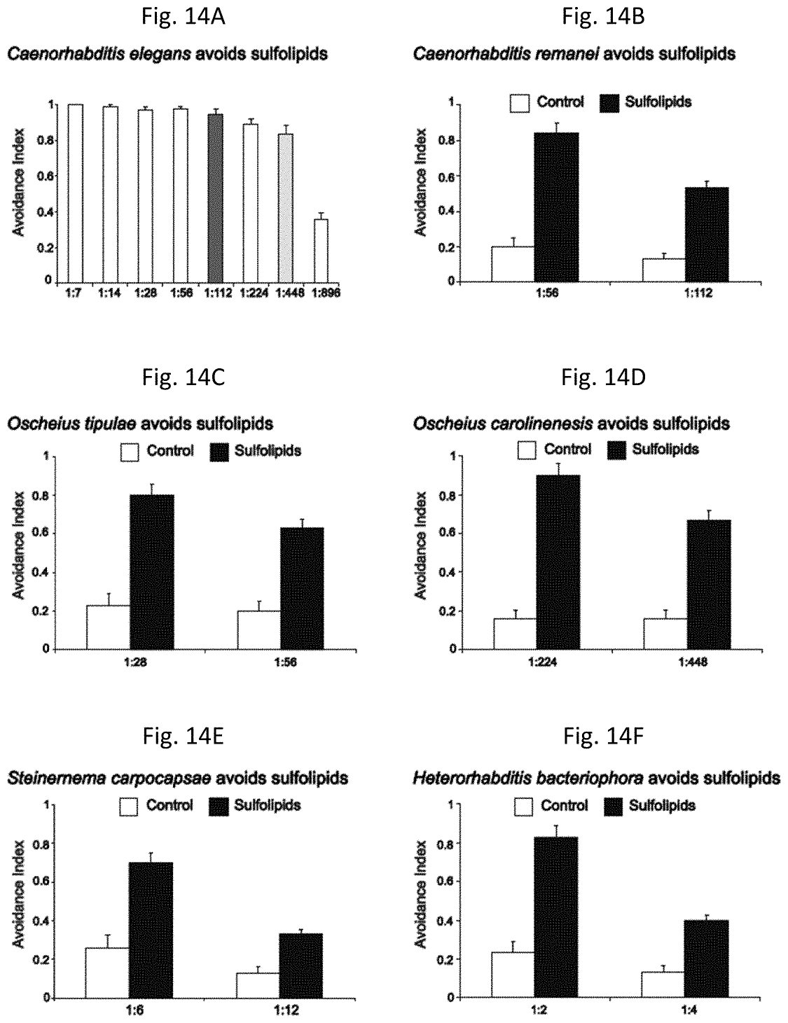

As shown in FIGS. 14A-14F, each of the nematode species tested, including Caenorhabditis elegans (FIG. 14A), Caenorhabditis remanei (FIG. 14B), Oscheius tipulae (FIG. 14C), Oscheius carolinenesis (FIG. 14D), Steinemema carpocapsae (FIG. 14E), and Heterohabditis bacteriophora (FIG. 14F) avoided sulfolipids in a dose dependent manner.

### Example 4

This example describes the ¹H and ¹³C NMR spectroscopic data for cysul#1 in methanol-d₄.

The structure of cysul#1 is

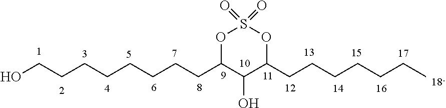 [SMILES: CCCCCCCC1OS(=O)(=O)OC(CCCCCCCCO)C1O]

Chemical shifts were referenced to δ(CD₂HOD)=3.31 and δ(¹³CD₃OD)=49.0. ¹³C chemical shifts were determined via HMBC and HSQC spectra. Spectra were acquired using the Bruker Avance 800 spectrometer. ¹H, ¹H-J-coupling constants were determined from the acquired ¹H or dqfCOSY spectra. HMBC correlations are from the proton(s) stated to the indicated ¹³C atom. ROESY in ACN. The spectral data are provided below in Table 1.

TABLE 1

| | | | 1H-1H coupling | HMBC | ROESY |
|---|---|---|---|---|---|
| Position | ¹³C[ppm] | ¹H [ppm] | constants (Hz) | Correlations | Correlations |
| 1 | 62.72 | 1a = 3.54 | J_{1,2} = 6.69 | 2, 3 | |
| | | 1a = 3.54 | | | |
| 2 | 33.40 | 2a = 1.53 | J_{2,3} = 5.93 | 1, 3, 4 | |
| | | 2b = 1.53 | | | |
| 3 | 26.64 | 3a = 1.36 | n/a | 4 | |
| | | 3b = 1.36 | | | |
| 4 | 30.20 | 4a = 1.35 | n/a | — | |
| | | 4b = 1.35 | | | |
| 5 | 28.80-30.20 | 5a = 1.30-1.40 | n/a | — | |
| | | 5b = 1.30-1.40 | | | |
| 6 | 29.78 | 6a = 1.39 | n/a | — | |
| | | 6b = 1.30-1.40 | | | |
| 7 | 26.06 | 7a = 1.56 | n/a | — | |
| | | 7b = 1.44 | | | |
| 8 | 32.14 | 8a = 2.05 | m | 10, 9, 7, 6 | |
| | | 8b = 1.79 | | | |
| 9 | 91.92 | 4.55 | J = 9.88 | 11, 10, 8, 7 | |
| | | | J = 4.17 | | |
| 10 | 68.76 | 3.72 | J = 3.79 | 11, 8 | 11 |
| | | | J = 2.48 | | |
| 11 | 87.00 | 4.82 | m | 13, 12, 10 | 10 |
| 12 | 30.11 | 12a = 1.93 | n/a | 14, 13, 11, 10 | |
| | | 12b = 1.74 | | | |
| 13 | 25.49 | 13a = 1.42 | n/a | — | |
| | | 13b = 1.49 | | | |
| 14 | 29.68 | 14a = 1.38 | n/a | — | |
| | | 14b = 1.35-1.40 | | | |
| 15 | 32.32 | 15a = 1.30-1.40 | n/a | — | |
| | | 15b = 1.30-1.40 | | | |
| 16 | 32.57 | 16a = 1.33 | n/a | — | |
| | | 16b = 1.34 | | | |
| 17 | 23.37 | 17a = 1.34 | n/a | 18, 16, 15 | |
| | | 17b = 1.34 | | | |
| 18 | 14.07 | 0.91 | J_{17,18} = | 17, 16 | |

### Example 5

This example describes ¹H and ¹³C NMR spectroscopic data for cysul#2 in methanol-d4.

The structure of cysul#2 is:

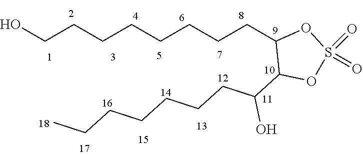 [SMILES: CCCCCCCC(O)C1OS(=O)(=O)OC1CCCCCCCCO]

Chemical shifts were referenced to δ(CD2HOD)=3.31 and δ(13CD3OD)=49.0. ¹³C chemical shifts were determined via HMBC and HSQC spectra. Spectra were acquired using the Bruker Avance 800 spectrometer. ¹H, ¹H-J-coupling constants were determined from the acquired 1H or dqfCOSY spectra. HMBC correlations are from the proton(s) stated to the indicated ¹³C atom. The spectral data are provided below in Table 2.

TABLE 2

| | | | ¹H-¹H | | |
|---|---|---|---|---|---|
| | | | coupling | HMBC | ROESY |
| Position | ¹³C [ppm] | ¹H [ppm] | constants (Hz) | Correlations | correlations |
| 1 | 62.72 | 1a = 3.54 | J_{1,2} = 6.69 | 2, 3 | |
| | | 1b = 3.54 | | | |
| 2 | 33.40 | 2a = 1.53 | J_{2,3} = 5.93 | 1, 3, 4 | |
| | | 2b = 1.53 | | | |
| 3 | 26.64 | 3a = 1.36 | n/a | 1, 2 | |
| | | 3b = 1.36 | | | |
| 4 | 30.23 | 4a = 1.35 | n/a | — | |
| | | 4b = 1.35 | | | |
| 5 | 29.80-30.20 | 5a = 1.30-1.40 | n/a | — | |
| | | 5b = 1.30-1.40 | | | |
| 6 | 29.87 | 6a = 1.34 | n/a | — | |
| | | 6b = 1.34 | | | |
| 7 | 26.05 | 7a = 1.48 | n/a | 9, 8, 6 | |
| | | 7b = 1.47 | | | |
| 8 | 32.82 | 8a = 1.81 | M | 6, 7, 9, 10 | |
| | | 8b = 1.87 | | | |
| 9 | 85.74 | 5.01 | J_{9,10} = 3.45 J_{9,8} = | 7, 10, 11 | 10, 11, 8, 7 |
| | | | 8.40 | | |
| 10 | 90.30 | 4.59 | J = 8.22 | 12, 11, 9, 8 | 9, 11, 8, 7 |
| | | | J = 2.51 | | |
| 11 | 69.08 | 3.69 | m | 12, 13 | 9, 10, 8, 12 |
| 12 | 33.92 | 12a = 1.58 | n/a | 10, 11, 13, 14 | 11 |
| | | 12b = 1.60 | | | |
| 13 | 26.49 | 13a = 1.54 | n/a | — | |
| | | 13b = 1.39 | | | |
| 14 | 29.97 | 14a = 1.35 | n/a | — | |
| | | 14b = 1.30-1.40 | | | |
| 15 | 32.32 | 15a = 1.30-1.40 | n/a | — | |
| | | 15b = 1.30-1.40 | | | |
| 16 | 32.57 | 16a = 1.33 | n/a | 17 | |
| | | 16b = 1.34 | | | |
| 17 | 23.37 | 17a = 1.34 | n/a | 18, 16, 15 | |
| | | 17b = 1.34 | | | |
| 18 | 14.08 | 0.91 | J_{17,18} = | 17, 16 | |
| 19 (11 | | 3.30 (Acetronitrile) | | | 12, 11 |
| oh | | | | | |
| proton) | | | | | |

### Example 6

This example describes the ¹H and ¹³C NMR spectroscopic data for osul#1 in methanol-d₄.

The compound osul#1 has the following structure:

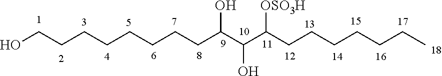

Chemical shifts were referenced to δ(CD₂HOD)=3.31 and δ(¹³CD₃OD)=49.0. ¹³C chemical shifts were determined via HMBC and HSQC spectra. Spectra were acquired using the Bruker Avance 800 spectrometer. ¹H, ¹H-J-coupling constants were determined from the acquired ¹H or dqfCOSY spectra. HMBC correlations are from the proton(s) stated to the indicated ¹³C atom. The spectral data are provided below in Table 3.

TABLE 3

| | | | | ¹H-¹H | |
|---|---|---|---|---|---|
| | | | | coupling | HMBC |
| Position | Corrected C13 | ¹³C [ppm] | ¹H [ppm] | constants (Hz) | Correlations |
| 1 | 62.72 | 61.60 | 1a = 3.54 | J_{1,2} = 6.73 | 2, 3 |
| | | | 1b = 3.54 | | |
| 2 | 33.39 | 32.26 | 2a = 1.53 | | 1, 3, 4 |
| | | | 2b = 1.53 | | |
| 3 | 26.64 | 25.51 | 3a = 1.36 | | 1, 2 |
| | | | 3b = 1.36 | | |
| 4 | 30.20 | 29.07 | 4a = 1.35 | | — |
| | | | 4b = 1.35 | | |
| 5 | | — | 5a = 1.30-1.40 | | — |
| | | | 5b = 1.30-1.40 | | |
| 6 | 30.24 | — | 6a = 1.34 | | — |
| | | | 6b = 1.34 | | |
| 7 | 26.72 | 24.83z | 7a = 1.35-1.50 | | 9, 8, 6 |
| | | | 7b = 1.35-1.500 | | |
| 8 | 30.38 | 29.23 | 8a = 1.57 | | 6, 7, 9, 10 |
| | | | 8b = 1.70 | | |
| 9 | 81.93 | 80.85 | 3.35 | | 7, 10, 11 |
| 10 | 74.14 | 73.01 | 3.62 | | 12, 11, 9, 8 |
| 11 | 81.22 | 80.08 | 4.42 | J_{11,12} = 4.43 | 12, 13 |
| | | | | J_{11,10} = 10.82 | |
| 12 | 31.58 | 30.46 | 12a = 1.82 | | 10, 11, 13, |
| | | | 12b = 1.69 | | 14 |
| 13 | 25.92 | 24.83 | 13a = 1.40-1.55 | | — |
| | | | 13b = 1.40-1.55 | | |
| 14 | 30.10 | — | 14a = 1.30-1.40 | | — |
| | | | 14b = 1.30-1.40 | | |
| 15 | | — | 15a = 1.30-1.40 | | — |
| | | | 15b = 1.30-1.40 | | |
| 16 | 32.83 | 31.70 | 16a = 1.31 | | 17 |
| | | | 16b = 1.31 | | |
| 17 | 23.60 | 22.30 | 17a = 1.34 | | 18, 16, 15 |
| | | | 17b = 1.34 | | |
| 18 | 14.14 | 13.01 | 0.91 | | 17, 16 |

### Example 7

This example describes the testing of the avoidance index exhibited by different species to sulfolipids at varied ratios.

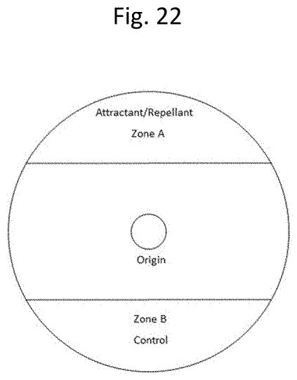

Sulfolipids were dissolved and diluted in M9 buffer. An agar plate was divided into three sections (FIG. 22) and 10 μl of each sulfolipid was placed in the middle of Zone A. M9 buffer was used as a control in the middle of Zone B. About 60 SCN J2s were placed on the middle of the plates. After 10 hours, nematodes in each zone were counted. The results are provided in the Tables 4-5 below.

TABLE 4
Sulfolipid #2 (Trial 1)

| Rep | Sulfolipid #2 (0.078 ug/ml) | M9 |
|---|---|---|
| 1 | 10 | 50 |
| 2 | 6 | 54 |
| 3 | 2 | 58 |
| Mean | 6 | 54 |

TABLE 5
Sulfolipid #3 (Trial 2)

| Rep | Sulfolipid #3 (0.034 ug/ml) | M9 |
|---|---|---|
| 1 | 14 | 46 |
| 2 | 12 | 48 |
| 3 | 22 | 38 |
| Mean | 16 | 44 |

### Example 8

This example demonstrates the sulfolipids can repel Juvenile stages (J2) of soybean cyst nematodes.

Sulfolipids were identified as the active ingredient of Pristionchus secretions that repel plant pathogenic nematodes. These data were published in Zheng et al 2018 Nat. Communications and commented in the Natural History Magazine and a number of other news and web outlets.

To elaborate on these studies, the sulfolipids were tested against two nematodes Heterorhabditis bacteriophora and Steinernema carpocapsae, both of which are insect parasites. These results support that sulfolipids act on a wide range of soil-dwelling pathogenic nematodes.

The compounds were also tested against soybean root nematodes. The juvenile stages of this pathogen is a soil dweller and is actively repelled by sulfolipids confirming its activity against an agricultural pest.

Sulfolipids are a large class of molecules and it is predicted that most if not all soil and/or water-dwelling nematodes will release them making them widely available in soil. Moreover, given then wide distribution any soil dweller is likely to be susceptible.

Sulfolipids might also play a role in the development of various soil-dwelling nematodes. For example, Pristionchus has two mouth forms—one with one prominent dorsal tooth and a second with two teeth (making it the more efficient predator) and these compounds might be involved a developing animal selecting to grow one or two teeth.

Pristionchus may be releasing these sulfolipids, not to warn the various prey (including plant pathogens), but to promote the development of the 2-toothed forms. Secretions from starved Pristionchus are more potent (FIG. 1a). This is also the condition in which we observe more 2-toothed forms (Serobyan et al Proc. Biol. Sci 281, 20141334 (2014). Taken together, it is speculated that the sulfolipids promote the development of the 2-toothed forms, which are more violet on prey nematodes (including plant pathogens). Consequently, the prey have evolved to detect these sulfolipids and escape. However, prolonged exposure leads to prey paralysis and death.

### REFERENCES

The following is a listing of references cited throughout the Example 1 via the number below.
1. Plutchik, R., Theor. Emot. 1, 3-31 (1980).
2. Apfelbach et al., Neurosci. Biobehay. Rev. 29, 1123-1144, S0149-7634(05)₀₀₀₉₈-9 [pii] (2005).
3. Papes et al., Cell 141, 692-703, S0092-8674(10)₀₀₃₅₅-7 [pii] (2010).
4. Yager et al., Curr. Opin. Neurobiol. 22, 201-207, S0959-4388(11)₀₀₂₂₉-7 [pii] (2012).
5. Takahashi et al., Front Behay. Neurosci. 8, 72 (2014).
6. Stevens et al., Proc Biol Sci 279, 417-426, rspb.2011.1932 [pii] (2012).
7. Kobayakawa et al., Nature 450, 503-508, nature06281 [pii] (2007).
8. Brechbuhl et al., Science 321, 1092-1095 (2008).
9. Tirindelli et al., Physiol. Rev. 89, 921-956, 89/3/921 [pii] (2009).
10. Stettler et al., Neuron 63, 854-864 (2009).
11. Brenner, S. The genetics of Caenorhabditis elegans. Genetics 77, 71-94 (1974).
12. Sommer, Pristionchus pacificus. WormBook, 1-8, https://doi.org/10.1895/wormbook.1.102.1 (2006).
13. Hong et al., Bioessays 28, 651-659 (2006).
14. Bumbarger et al., Cell 152, 109-119, S0092-8674(12)₀₁₅₀₀-0 [pii] (2013).
15. Serobyan et al., Evol. Dev. 15, 161-170 (2013).
16. White et al., Philos. Trans. R. Soc. Lond. B Biol. Sci. 314, 1-340 (1986).
17. de Bono et al., Annu Rev. Neurosci. 28, 451-501 (2005).
18. Barriere et al., WormBook, 1-19, https://doi.org/10.1895/wormbook.1.115.2 (2014).
19. Felix, M. A. et al. BMC Evol. Biol. 13, 10 (2013).
20. Serobyan et al., Proc. Biol. Sci.281, 20141334 (2014).
21. Schafer, W. R. Egg-laying. WormBook, 1-7, https://doi.org/10.1895/wormbook.1.38.1 (2005).
22. Forseth et al., Curr. Opin. Chem. Biol. 15, 38-47 (2011).
23. Pungaliya et al., Proc. Natl Acad. Sci. USA 106, 7708-7713, 0811918106 [pii] (2009).
24. Hilliard et al., Embo J. 23, 1101-1111 (2004).
25. Bargmann et al., Curr. Biol. 12, 730-734 (2002).
26. Chalasani et al., Nature 450, 63-70, nature06292 [pii] (2007).
27. Ramot et al., Nat. Neurosci. 11, 908-915 (2008).
28. Komatsu et al., Brain Res. 821, 160-168 (1999).
29. Lee et al., PLoS Genet. 4, e1000213 (2008).
30. Jose et al., Genetics175, 93-105 (2007).
31. Campos et al., Behay. Brain Res. 240, 160-170 (2013).
32. Lee et al., J. Neurosci. 19, 159-167 (1999).
33. Jin et al., J. Neurosci. 19, 539-548 (1999).
34. Pinna et al., Psychopharmacology (Berl.) 186, 362-372 (2006).
35. Pinna et al., Curr. Opin. Pharmacol. 9, 24-30 (2009).
36. McIntire et al., Nature364, 337-341 (1993).
37. Turek et al., Curr. Biol. 23, 2215-2223 (2013).
38. Turek et al., eLife 5, https://doi.org/10.7554/eLife.12499 (2016).
39. Stowe et al., Proc. Natl Acad. Sci. USA 92, 23-28 (1995).
40. Fujita et al., J. Nat. Prod. 65, 1936-1938 (2002).
41. Nakao et al., Tetrahedron 49, 11183-11188 (1993).
42. Yasumoto et al., Tetrahedron Lett. 46, 4765-4767 (2005).
43. White et al., Org. Lett. 18, 1124-1127 (2016).
44. O'Doherty et al., Org. Lett. 13, 5900-5903 (2011).
45. Alborn et al., Proc. Natl Acad. Sci. USA 104, 12976-12981 (2007).
46. Kniazeva et al., PLoS Biol. 2, E257 (2004).
47. Ragsdale et al., Evolution 70, 2155-2166 (2016).
48. Ragsdale et al., Cell 155, 922-933 (2013).
49. White & Jorgensen, Neuron 75, 593-600, S0896-6273(12)₀₀₅₇₃-9 [ph] (2012).
50. Ludewig & Schroeder, Ascaroside signaling in C. elegans. WormBook, 1-22, https://doi.org/10.1895/wormbook.1.155.1 (2013).
51. de Bono et al., Nature 419, 899-903 (2002).
52. Calhoun et al., Neuron 86, 428-441 (2015).
53. Beverly et al., J. Neurosci. 31, 11718-11727 (2011).
54. Leinwand et al., eLife 4, e10181 (2015).
55. Gutierrez et al., Neuron 77, 845-858 (2013).
56. Zagotta et al., Annu Rev. Neurosci. 19, 235-263 (1996).
57. Kaupp et al., Physiol. Rev. 82, 769-824 (2002).
58. Chen et al., Nature 362, 764-767 (1993).
59. Bradley et al., J. Neurosci. 17, 1993-2005 (1997).
60. Tobin et al., Neuron 35, 307-318, 50896627302007572 [ph] (2002).
61. Baldwin et al., Curr. Top. Behay. Neurosci. 2, 453-467 (2010).
62. Fuller et al., Prog. Drug Res 45, 167-204 (1995).
63. Kullyev et al., Genetics 186, 929-941, genetics.110.118877 [ph] (2010).
64. Owens et al., J. Pharmacol. Exp. Ther.283, 1305-1322 (1997).
65. Tian et al., Nat. Methods 6, 875-881 (2009).
66. Troemel, et al., Cell 83, 207-218 (1995).
67. Peckol, et al., Proc. Natl Acad. Sci. USA98, 11032-11038 (2001).
68. Mello, C. & Fire, A. DNA transformation. Methods Cell Biol. 48, 451-482 (1995).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range and each endpoint, unless otherwise indicated herein, and each separate value and endpoint is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A composition comprising a nematode deterrent comprising a compound of Formula I: 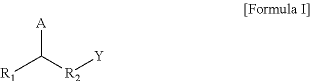
wherein:
A is OSO₃ or OSO₃H
R₁ is a C₁-C₂₄ branched or linear alkyl or alkenyl, optionally substituted with —OH or ═O at one or more carbon atoms,
R₂ is a C₁-C₁₄ branched or linear alkyl or alkenyl, optionally substituted with —OH or ═O at one or more carbon atoms, and
Y is —OH or —COOH;
or a salt thereof.

2. The composition of claim 1, wherein R₂ is a C₃-C₁₂ branched or linear alkyl or alkenyl, optionally substituted with —OH or ═O at one or more carbon atoms.

3. The composition of claim 2, wherein R₂ is a C₄-C₁₀ branched or linear alkyl or alkenyl.

4. The composition of claim 1, wherein R₂ is substituted —OH or ═O at one, two, or three carbon atoms.

5. The composition of claim 1, wherein R₁ is substituted —OH or ═O at one, two, or three carbon atoms.

6. The composition of claim 1, comprising a structure of Formula II: 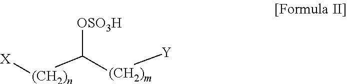
wherein:
X is —CH₃, —CH₂CH₃, —CH(CH₃)₂;
Y is —OH or —COOH;
n is an integer within 1 to 21; and
m is an integer within 1 to 13.

7. The composition of claim 6, wherein X is —CH(CH₃)₃.

8. The composition of claim 6, wherein Y is —OH.

9. The composition of claim 6, wherein Y is —COOH

10. The composition of claim 6, wherein m is 2 or 3.

11. The composition of claim 6, wherein n is 7 or 8 or 9.

12. The composition of claim 6, wherein X is —CH(CH₃)₂, Y is —OH, n is 3, and m is 8.

13. The composition of claim 6, wherein X is —CH(CH₃)₂, Y is —COOH, n is 2, and m is 8.

14. The composition of claim 6, wherein X is —CH(CH₃)₂, Y is —OH, n is 2, and m is 9.

15. The composition of claim 6, wherein X is —CH(CH₃)₂, Y is —COOH, n is 3, and m is 7.

16. The composition of claim 1, comprising a structure selected from the group consisting of:

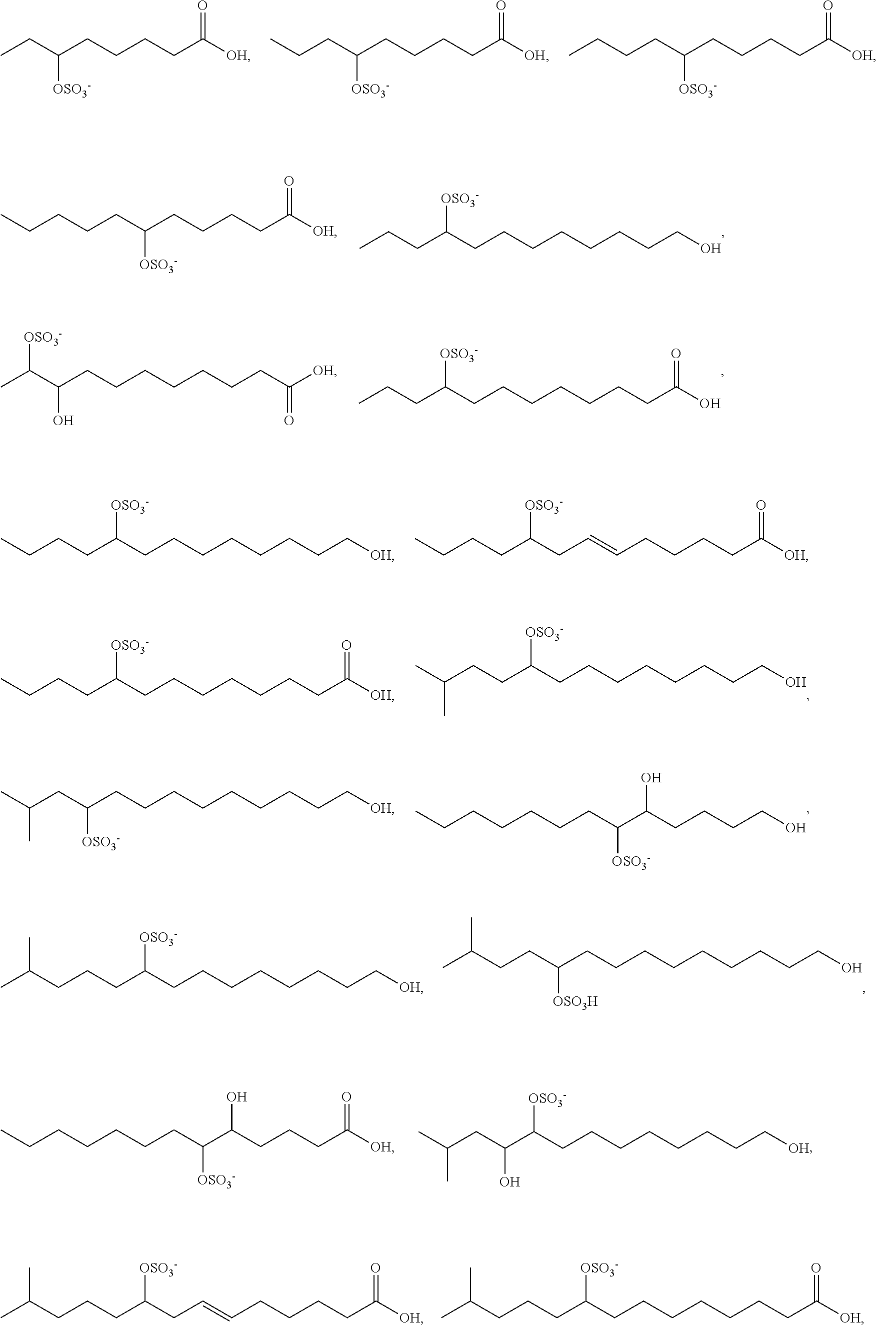

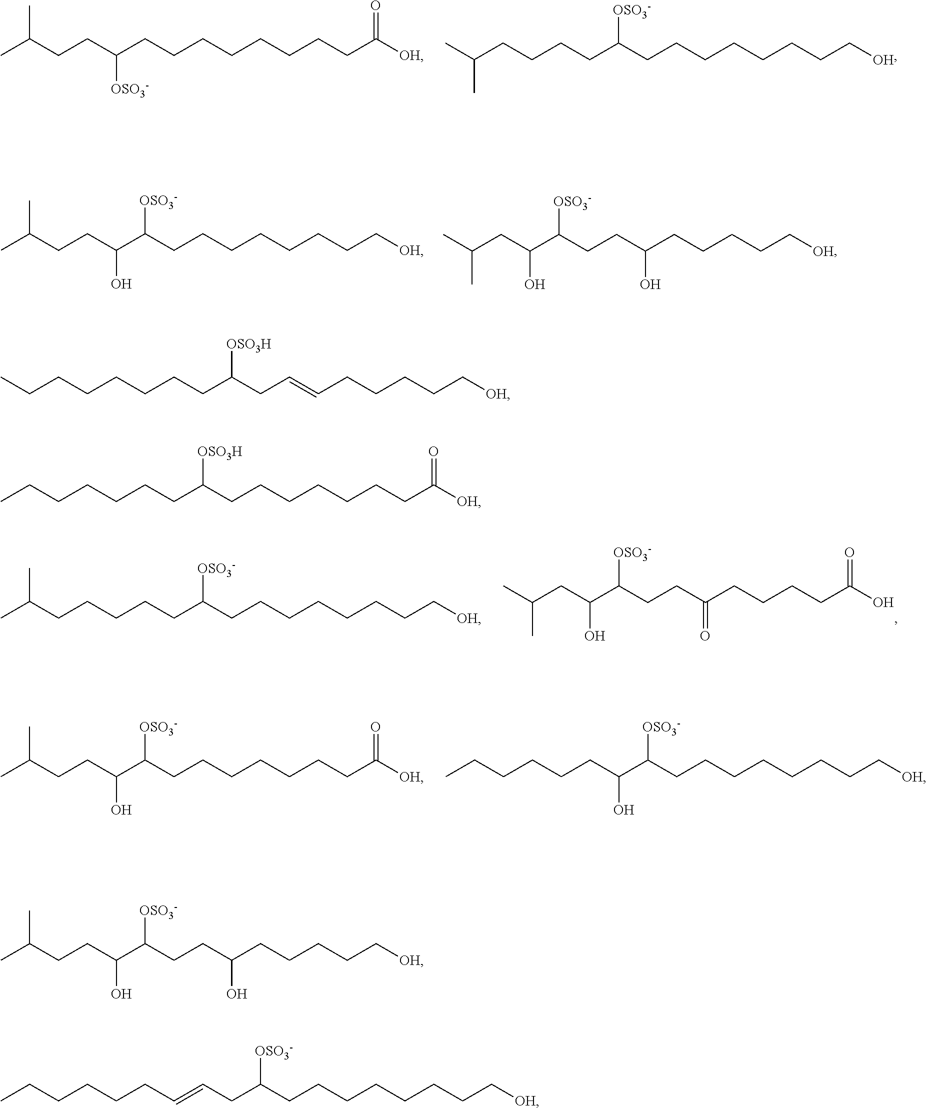

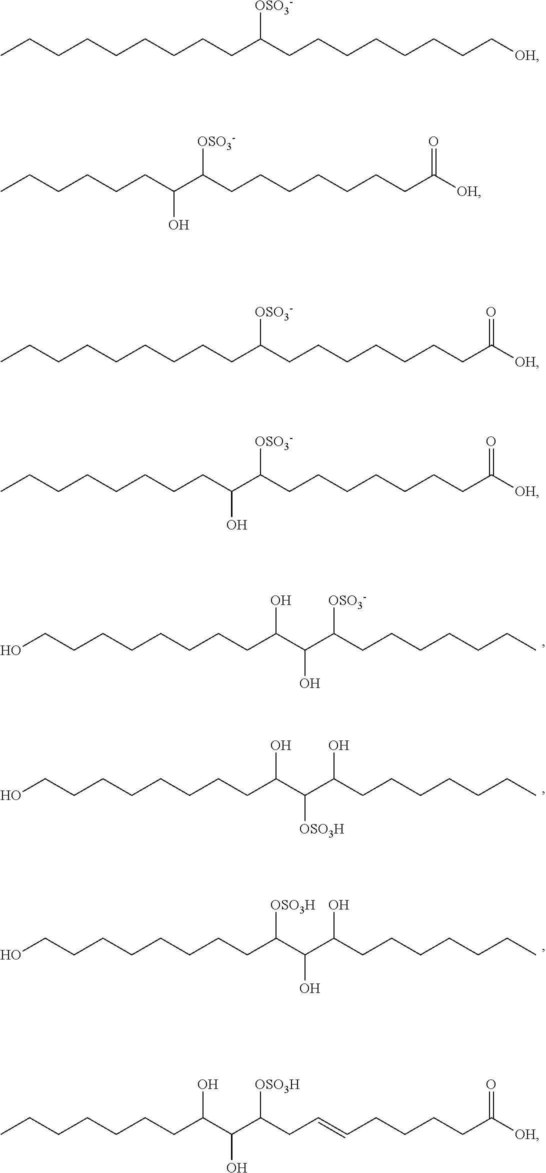

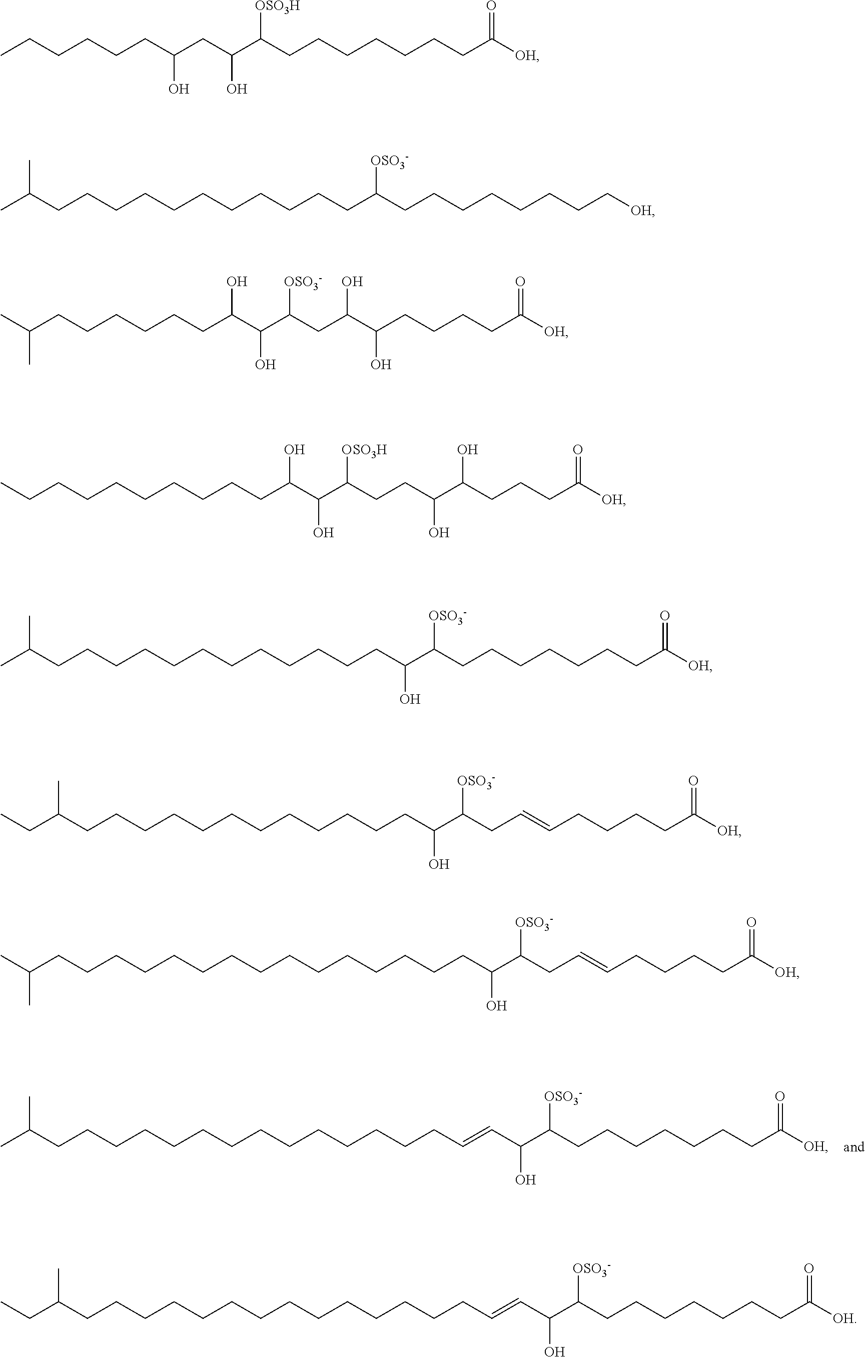

17. The composition of claim 1, comprising a mixture of different compounds of Formula I and/or II.

18. (canceled)

19. The composition of claim 1, comprising (a) aqueous solution or a liquid suspension or an emulsion comprising the compound(s), (b) a solid particle comprising the compound(s), optionally, a plurality of the solid particles compressed into a solid form, or (c) a combination thereof.

20.-25. (canceled)

26. A method for treating or preventing a nematode infestation of an agricultural crop, comprising applying the composition of claim 1 to the plants or soil of the agricultural crop in an amount effective to treat or prevent a nematode infestation of the agricultural crop.

27. A method for treating or preventing a nematode infection in a subject in need thereof, comprising administering the composition of claim 1 to the subject in an amount effect effective to treat or prevent the nematode infection in the subject.

28.-32. (canceled)
